(19) United States
(12) Patent Application Publication
(10) Pub. No.: US 2023/0232427 A1
(43) Pub. Date: Jul. 20, 2023

(54) TECHNIQUES FOR SUB-BAND PRECODING IN SIDELINK COMMUNICATIONS

(71) Applicant: QUALCOMM Incorporated, San Diego, CA (US)

(72) Inventors: Gabi SARKIS, San Diego, CA (US); Alexandros MANOLAKOS, Escondido, CA (US); Shuanshuan WU, San Diego, CA (US); Kapil GULATI, Belle Mead, NJ (US)

(21) Appl. No.: 18/001,699

(22) PCT Filed: Jul. 13, 2021
(86) PCT No.: PCT/US2021/041472

§ 371 Date: Dec. 13, 2022

(30) Foreign Application Priority Data
Aug. 13, 2020 (GR) 20200100478

(51) Int. Cl. H04W 72/25

(52) U.S. Cl. CPC H04W 72/25

(57) ABSTRACT

According to a first method, a first user equipment (UE) may receive sidelink control information (SCI) over a sidelink communication link between the first UE and a second UE. The SCI may indicate a precoding resource block group (PRG) size associated with sidelink communications with the second UE. The first UE may determine the PRG size for communications over the sidelink communication link based at least in part on the SCI. The first UE may then receive a sidelink message from the second UE via the sidelink communication link based on the determined PRG size, and may transmit a sidelink message to the second UE based on the determined PRG size. According to a second method, a first user equipment may identify a sidelink configuration for a sidelink communication link between the first UE and a second UE, determine a PRG size for communications over the sidelink communication link based at least in part on the sidelink configuration, and receive, from the second UE, a sidelink message based at least in part on the PRG size.

### CROSS REFERENCE

The present Application is a 371 national stage filing of International PCT Application No. PCT/US2021/041472 by SARKIS et al. entitled “TECHNIQUES FOR SUB-BAND PRECODING IN SIDELINK COMMUNICATIONS,” filed Jul. 13, 2021; and claims priority to Greece Patent Application No. 20200100478 by SARKIS et al., entitled “TECHNIQUES FOR SUB-BAND PRECODING IN SIDELINK COMMUNICATIONS,” filed Aug. 13, 2020, each of which is assigned to the assignee hereof, and each of which is expressly incorporated by reference in its entirety herein.

### FIELD OF TECHNOLOGY

The following relates to wireless communications and more specifically to techniques for sub-band precoding in sidelink communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A wireless communications system may support a number of UEs which may be capable of direct communication with each other (e.g., via sidelink communication links). In such systems, transmissions between devices (e.g., between a base station and a UE 115 or between different UEs) may be performed using messages transmitted in various beam directions. However, in some cases, sidelink communications may have reduced flexibility for beamforming as compared to access link communications between a base station and a UE.

### SUMMARY

The described techniques relate to improved methods, systems, devices, and apparatuses that support techniques for sub-band precoding in sidelink communications. The described techniques provide for signaling precoding resource block group (PRG) sizes for sidelink communications such that sub-band precoding may be used for sidelink communications. A user equipment (UE) may determine a PRG size for sidelink communications statically or semi-statically based on radio resource control (RRC) signaling, pre-configured PRG sizes associated with a resource pool allocated for a physical sidelink shared channel (PSSCH), a determined sub-channel size, or any combination thereof. Additionally or alternatively, the UE may determine the PRG size for sidelink communications dynamically based on indications within sidelink control information (SCI) including a modulation and coding scheme (MCS) index, a dedicated bit field, or any combination thereof.

A method of wireless communication at a first UE is described. The method may include receiving, from a second UE, SCI over a sidelink communication link between the first UE and the second UE, the SCI indicating a PRG size, determining the PRG size for communications over the sidelink communication link based on the SCI, and receiving, from the second UE, a sidelink message via the sidelink communication link based on the determined PRG size.

An apparatus for wireless communication at a first UE is described. The apparatus may include a processor, memory coupled with the processor, and instructions stored in the memory. The instructions may be executable by the processor to cause the apparatus to receive, from a second UE, SCI over a sidelink communication link between the first UE and the second UE, the SCI indicating a PRG size, determine the PRG size for communications over the sidelink communication link based on the SCI, and receive, from the second UE, a sidelink message via the sidelink communication link based on the determined PRG size.

Another apparatus for wireless communication at a first UE is described. The apparatus may include means for receiving, from a second UE, SCI over a sidelink communication link between the first UE and the second UE, the SCI indicating a PRG size, determining the PRG size for communications over the sidelink communication link based on the SCI, and receiving, from the second UE, a sidelink message via the sidelink communication link based on the determined PRG size.

A non-transitory computer-readable medium storing code for wireless communication at a first UE is described. The code may include instructions executable by a processor to receive, from a second UE, SCI over a sidelink communication link between the first UE and the second UE, the SCI indicating a PRG size, determine the PRG size for communications over the sidelink communication link based on the SCI, and receive, from the second UE, a sidelink message via the sidelink communication link based on the determined PRG size.

Some examples of the method, apparatuses, and non-transitory computer-readable medium described herein may further include operations, features, means, or instructions for identifying, from the SCI, an MCS index for the communications over the sidelink communication link, where determining the PRG size may be based on the MCS index.

In some examples of the method, apparatuses, and non-transitory computer-readable medium described herein, determining the PRG size may include operations, features, means, or instructions for determining the PRG size based on the MCS index satisfying one or more thresholds.

In some examples of the method, apparatuses, and non-transitory computer-readable medium described herein, the SCI indicates the PRG size via a bit value, a SCI format, a SCI rate-matching offset, a target code rate, or any combination thereof, and where determining the PRG size may be based on the bit value and an MCS index, the SCI format, the SCI rate-matching offset, the target code rate, or any combination thereof.

Some examples of the method, apparatuses, and non-transitory computer-readable medium described herein may further include operations, features, means, or instructions for receiving a configuration message indicating one or more PRG sizes for communications over the sidelink communication link between the first UE and the second UE, where determining the PRG size may be based on the one or more PRG sizes and the SCI.

Some examples of the method, apparatuses, and non-transitory computer-readable medium described herein may further include operations, features, means, or instructions for transmitting, to the second UE, a second sidelink message via the sidelink communication link based on determining the PRG size, where the second sidelink message may be precoded based on the PRG size.

Some examples of the method, apparatuses, and non-transitory computer-readable medium described herein may further include operations, features, means, or instructions for determining a second PRG size for communications over a second sidelink communication link between the first UE and a third UE, transmitting, to the third UE, a second SCI via the second sidelink communication link, the second SCI indicating the second PRG size, the second SCI including decoding information for decoding an additional SCI different from the second SCI, and transmitting, to the third UE, a second sidelink message via the second sidelink communication link based on transmitting the second SCI, where the second sidelink message may be precoded based on the second PRG size.

Some examples of the method, apparatuses, and non-transitory computer-readable medium described herein may further include operations, features, means, or instructions for determining one or more precoders for transmitting the second sidelink message based on the second PRG size, where transmitting the second sidelink message may be based on determining the one or more precoders.

In some examples of the method, apparatuses, and non-transitory computer-readable medium described herein, determining the one or more precoders may include operations, features, means, or instructions for determining an indication of a wideband precoding scheme or sub-band precoding scheme for transmitting the second sidelink message based on the second PRG size.

In some examples of the method, apparatuses, and non-transitory computer-readable medium described herein, a set of PRGs of the sidelink message may be arranged based on a first resource block of a set of resources allocated for the sidelink message.

In some examples of the method, apparatuses, and non-transitory computer-readable medium described herein, a set of PRGs of the sidelink message may be arranged based on a sidelink common resource block.

Some examples of the method, apparatuses, and non-transitory computer-readable medium described herein may further include operations, features, means, or instructions for determining a bandwidth difference between a sub-channel bandwidth and a physical sidelink control channel bandwidth for communications over the sidelink communication link, and determining one or more of the PRG size, the sub-channel bandwidth, or the PSCCH bandwidth based on the bandwidth difference being an integer multiple of the PRG size.

Some examples of the method, apparatuses, and non-transitory computer-readable medium described herein may further include operations, features, means, or instructions for determining that the PRG size may be equal to a sub-channel bandwidth of a set of resources allocated for the sidelink message.

Some examples of the method, apparatuses, and non-transitory computer-readable medium described herein may further include operations, features, means, or instructions for determining that the PRG size may be equal to a predefined value based on the PRG size being less than a bandwidth of a set of resources allocated for the sidelink message.

Some examples of the method, apparatuses, and non-transitory computer-readable medium described herein may further include operations, features, means, or instructions for determining that the PRG size may be equal to a bandwidth of a set of resources allocated for the sidelink message.

A method of wireless communication at a first UE is described. The method may include identifying a sidelink configuration for a sidelink communication link between the first UE and a second UE, determining a PRG size for communications over the sidelink communication link based on the sidelink configuration, and receiving, from the second UE, a sidelink message based on the PRG size.

An apparatus for wireless communication at a first UE is described. The apparatus may include a processor, memory coupled with the processor, and instructions stored in the memory. The instructions may be executable by the processor to cause the apparatus to identify a sidelink configuration for a sidelink communication link between the first UE and a second UE, determine a PRG size for communications over the sidelink communication link based on the sidelink configuration, and receive, from the second UE, a sidelink message based on the PRG size.

Another apparatus for wireless communication at a first UE is described. The apparatus may include means for identifying a sidelink configuration for a sidelink communication link between the first UE and a second UE, determining a PRG size for communications over the sidelink communication link based on the sidelink configuration, and receiving, from the second UE, a sidelink message based on the PRG size.

A non-transitory computer-readable medium storing code for wireless communication at a first UE is described. The code may include instructions executable by a processor to identify a sidelink configuration for a sidelink communication link between the first UE and a second UE, determine a PRG size for communications over the sidelink communication link based on the sidelink configuration, and receive, from the second UE, a sidelink message based on the PRG size.

In some examples of the method, apparatuses, and non-transitory computer-readable medium described herein, identifying the sidelink configuration may include operations, features, means, or instructions for receiving, from the second UE, radio resource control signaling indicating the PRG size, where the PRG size may be determined based on the radio resource control (RRC) signaling.

In some examples of the method, apparatuses, and non-transitory computer-readable medium described herein, identifying the sidelink configuration may include operations, features, means, or instructions for receiving an indication of one or more sets of resources allocated for communications over the sidelink communication link, where determining the PRG size may be based on the indication of the one or more sets of resources allocated for communications over the sidelink communication link.

In some examples of the method, apparatuses, and non-transitory computer-readable medium described herein, identifying the sidelink configuration may include operations, features, means, or instructions for receiving a control message including an indication of a sub-channel bandwidth associated with the sidelink communication link, where determining the PRG size may be based on the indication of the sub-channel bandwidth.

In some examples of the method, apparatuses, and non-transitory computer-readable medium described herein, determining the PRG size may include operations, features, means, or instructions for determining the PRG size based on the sub-channel bandwidth satisfying one or more thresholds.

Some examples of the method, apparatuses, and non-transitory computer-readable medium described herein may further include operations, features, means, or instructions for receiving a control message including an indication of a quantity of sub-channels associated with the sidelink communication link, where determining the PRG size may be based on the indication of the quantity of sub-channels associated with the sidelink communication link.

Some examples of the method, apparatuses, and non-transitory computer-readable medium described herein may further include operations, features, means, or instructions for transmitting, to the second UE, a second sidelink message via the sidelink communication link based on the PRG size, where the second sidelink message may be precoded based on the PRG size.

Some examples of the method, apparatuses, and non-transitory computer-readable medium described herein may further include operations, features, means, or instructions for determining a second PRG size for communications over a second sidelink communication link between the first UE and a third UE, transmitting, to the third UE, RRC signaling via the second sidelink communication link, the RRC signaling indicating the second PRG size, and transmitting, to the third UE, a second sidelink message via the second sidelink communication link based on transmitting the RRC signaling, where the second sidelink message may be precoded based on the second PRG size.

In some examples of the method, apparatuses, and non-transitory computer-readable medium described herein, a set of PRGs of the sidelink message may be arranged based on a first resource block of a set of resources allocated for the sidelink message.

In some examples of the method, apparatuses, and non-transitory computer-readable medium described herein, a set of PRGs of the sidelink message may be arranged based on a sidelink common resource block.

Some examples of the method, apparatuses, and non-transitory computer-readable medium described herein may further include operations, features, means, or instructions for determining a bandwidth difference between a sub-channel bandwidth and a physical sidelink control channel bandwidth for communications over the sidelink communication link, and determining one or more of the PRG size, the sub-channel bandwidth, or the PSCCH bandwidth based on the bandwidth difference being an integer multiple of the PRG size.

Some examples of the method, apparatuses, and non-transitory computer-readable medium described herein may further include operations, features, means, or instructions for determining that the PRG size may be equal to a sub-channel bandwidth of a set of resources allocated for the sidelink message.

Some examples of the method, apparatuses, and non-transitory computer-readable medium described herein may further include operations, features, means, or instructions for determining that the PRG size may be equal to a predefined value based on the PRG size being less than a bandwidth of a set of resources allocated for the sidelink message.

### BRIEF DESCRIPTION OF THE DRAWINGS

FIG. 1 illustrates an example of a wireless communications system that supports techniques for sub-band precoding in sidelink communications in accordance with various aspects of the present disclosure.

FIG. 2 illustrates an example of a wireless communications system that supports techniques for sub-band precoding in sidelink communications in accordance with various aspects of the present disclosure.

FIG. 3 illustrates an example of a process flow that supports techniques for sub-band precoding in sidelink communications in accordance with various aspects of the present disclosure.

FIG. 4 illustrates an example of a process flow that supports techniques for sub-band precoding in sidelink communications in accordance with various aspects of the present disclosure.

FIGS. 5 and 6 show block diagrams of devices that support techniques for sub-band precoding in sidelink communications in accordance with various aspects of the present disclosure.

FIG. 7 shows a block diagram of a communications manager that supports techniques for sub-band precoding in sidelink communications in accordance with various aspects of the present disclosure.

FIG. 8 shows a diagram of a system including a device that supports techniques for sub-band precoding in sidelink communications in accordance with various aspects of the present disclosure.

FIGS. 9 through 12 show flowcharts illustrating methods that support techniques for sub-band precoding in sidelink communications in accordance with various aspects of the present disclosure.

### DETAILED DESCRIPTION

Wireless systems may support both access links (e.g., Uu links) and sidelinks (e.g., PC5 links) for communications between wireless devices. A Uu communications link between a user equipment (UE) and a base station may be configured to support both wideband precoding and sub-band precoding. In this regard, a precoding resource block group (PRG) size may be selected to include one or more resource blocks (RBs) in the case of sub-band precoding or an entire bandwidth in the case of wideband precoding. Comparatively, a sidelink between a first UE and a second UE (e.g., for data transmissions via a physical sidelink shared channel (PSSCH)) may only be configured for wideband precoding. However, the inability to select or configure PRG sizes (e.g., associated with sub-band precoding) for the PSSCH may negatively affect the performance of communications carried out over the sidelink.

Accordingly, techniques described herein are directed toward signaling PRG sizes for sidelink communications such that sub-band precoding (in addition to wideband precoding) may be used. As an example, a UE may determine a PRG size for sidelink communications (e.g., via PSSCH) statically or semi-statically. For example, the UE may be configured to determine a static (or semi-static) PRG size based on PC5 radio resource control (RRC) signaling or based on a pre-configured PRG size associated with a resource pool allocated for PSSCH. In other examples, the PRG size may be based on a sub-channel size threshold, where different PRG sizes may be applied based on a determined size of the sub-channel (e.g., in terms of a number of RBs), and whether the determined sub-channel size satisfies one or more thresholds.

The UE may be additionally or alternatively be configured to determine the PRG size dynamically. For example, the PRG size may be determined based on sidelink control information (SCI) received from another UE. In some aspects, the PRG size may be determined based on whether a modulation and coding scheme (MCS) index value indicated in SCI (e.g., SCI-1) is above or below a threshold MCS value. As an example, when the MCS index value is below a threshold MCS value, a first PRG size may be used, whereas an MCS index value above the threshold MCS value may indicate a second PRG size different from the first PRG size. The PRG size may also be explicitly signaled within a field (e.g., a bit field) of the SCI. Upon determining the PRG size, the UE may be configured to perform sub-band precoding/decoding for sidelink messages based on the determined PRG size.

Other aspects of the disclosure relate to performing PRG partitioning for sidelink communications, where sidelink PRGs may be partitioned starting from a lowest numbered RB in an allocated PSSCH, or partitioned starting from a sidelink common RB (e.g., RB 0). In some other cases, if there is a difference between a physical sidelink control channel (PSCCH) bandwidth and the size of the sub-channel, there may be a configured relationship between the PSCCH size, the PRG size, and the sub-channel size. For instance, if the PRG size is less than the PSSCH bandwidth, then the difference between the PSCCH size and the sub-channel size may be a multiple of the PRG size. In other examples, the PSCCH size may be equal to the sub-channel size. These relationships may be configured or pre-configured, and a UE may not expect any different relationships when communicating over the sidelink communication link, and a PRG size may be implicitly determined to satisfy the relationship conditions. In other cases, if the UE is unable to determine a PRG size that is less than the PSSCH bandwidth, then a predetermined PRG size value (e.g., 1 RB) may be used, or the PRG size may be equal to the PSSCH bandwidth.

Aspects of the subject matter described in this disclosure may be implemented to realize one or more of the following technical improvements, among other advantages. The described techniques employed by wireless devices may provide benefits and enhancements to wireless communications carried out between UEs, which may include increased reliability for sidelink communications. For instance, the techniques described herein may increase reliability when performing beamforming and channel estimation, resulting in more efficient and reliable wireless communications, thereby increasing data rates and link capacity. In some examples, signaling PRG sizes, including sizes of PRGs used for subband precoding, in sidelink communications may support increased flexibility for wireless communications between UEs.

Aspects of the disclosure are initially described in the context of wireless communications systems. Aspects of the disclosure are additionally described in the context of example process flows. Aspects of the disclosure are further illustrated by and described with reference to apparatus diagrams, system diagrams, and flowcharts that relate to techniques for sub-band precoding in sidelink communications.

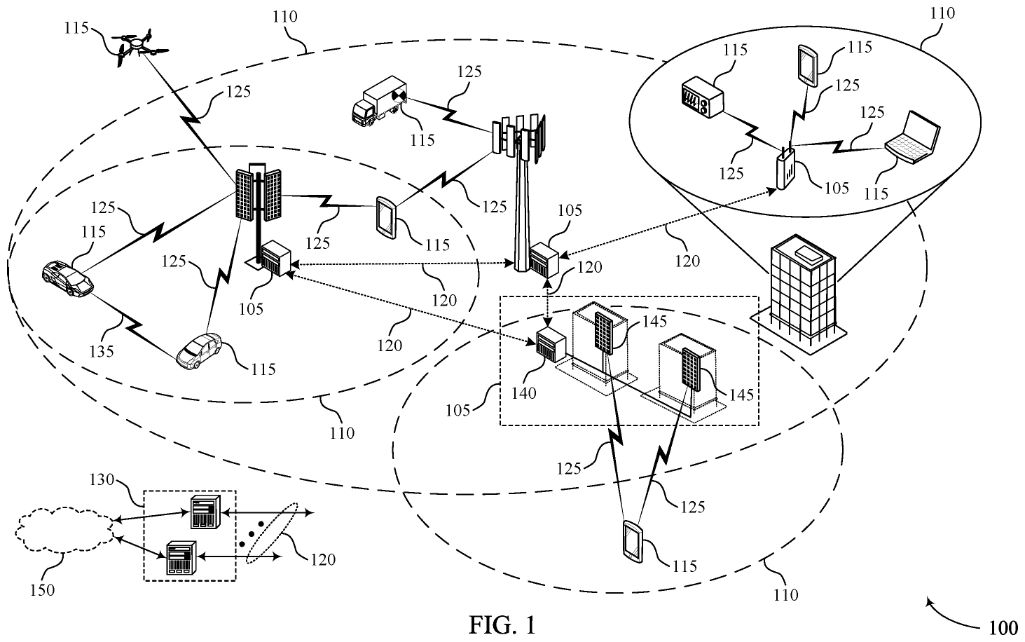

FIG. 1 illustrates an example of a wireless communications system 100 that supports techniques for sub-band precoding in sidelink communications in accordance with various aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). In some examples, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at various orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with some orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

In some examples, precoding may be used to map different transmission layers to a set of antenna ports using the precoding matrix. In such cases, a transmitting device (e.g., a base station 105 or a UE 115) may precode one or more transmission layers, map the precoded signal to a set of one or more resources, and map the resources to one or more antennas prior to transmission to a receiving device (e.g., a base station 105 or another UE 115). In some examples, the receiving device may make assumptions regarding the precoding used by the transmitting device. For instance, the receiving device may assume that some precoding matrix, W, is used for the precoding. In addition, the receiving device may determine physical RB groups (which may also be referred to as PRGs herein) for which a same precoding was applied. Here, the receiving device may utilize the size of the PRGs for channel estimation, where it may be determined that one PRG has a first precoding and another PRG has a different precoding. Different PRG sizes of the PRGs may enable varying degrees of flexibility for channel estimation and communications between devices. A receiving device may receive a transmission over a channel (e.g., via PDSCH, or PSSCH, or the like) and may determine one or more PRGs used for such transmission based on a PRG size used for precoding, where each PRG may have a same precoding matrix applied prior to transmission. In some examples, a PRGs size may be indicated to a receiving device. For instance, and as described herein, a UE 115 may transmit an indication of a PRG size to another UE 115 (e.g., for PSSCH messages) using SCI, or RRC signaling, or any combination thereof. As such, a receiving UE 115 may identify the PRG size used (e.g., for sub-band precoding of a sidelink message), which may be used for channel estimation, beamforming, or other purposes.

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The UEs 115 and the base stations 105 of the wireless communications system 100 may support techniques for sub-band precoding in sidelink communications. The wireless communications system 100 provide for signaling PRG sizes for sidelink communications such that sub-band precoding may be used for sidelink communications (in addition to wideband precoding). A first UE 115-a of the wireless communications system 100 may determine a PRG size for sidelink communications with a second UE 115-b statically or semi-statically based on RRC signaling, pre-configured PRG sizes associated with a resource pool allocated for a PSSCH, a determined sub-channel size, or any combination thereof. Additionally or alternatively, the first UE 115-a may determine the PRG size for sidelink communications with the second UE 115-b dynamically based on indications within SCI including an MCS index, a dedicated bit field, or any combination thereof.

For example, a first UE 115-a of the wireless communications system 100 may identify a sidelink configuration for a sidelink communication link between the first UE 115-a and the second UE 115-b. The first UE 115-a may identify the sidelink configuration based on signaling exchanged within the wireless communications system 100 including PC5 RRC signaling received from the second UE 115-b, an indication of one or more sets of resources allocated for communications over the sidelink communication link received from a base station 105 or another UE 115, control messages indicating a sub-channel bandwidth or a quantity of sub-channels associated with the sidelink communications link received from the base station 105 or another UE 115, or any combination thereof. Upon identifying the sidelink configuration, the first UE 115-a may determine a PRG size for communications over the sidelink communication link with the second UE 115-b based on the sidelink configuration. The first UE 115-a may then receive sidelink messages from the second UE 115-b, and transmit sidelink messages to the second UE 115-b, based on the determined PRG size.

Additionally or alternatively, the first UE 115-a may determine PRG size for sidelink communications dynamically. For example, the first UE 115-a may receive SCI (e.g., SCI-1) from the second UE 115-b over the sidelink communication link between the first UE 115-a and the second UE 115-b, where the SCI indicates a PRG size. The first UE 115-a may determine the PRG size for communications over the sidelink communication link based on the received SCI. In some aspects, the PRG size may be determined based on whether an MCS index value indicated in SCI is above or below a threshold MCS value. Additionally or alternatively, the PRG size may be explicitly signaled within a field of the SCI (e.g., within a bit field). The first UE 115-a may then receive sidelink messages from the second UE 115-b, and transmit sidelink messages to the second UE 115-b, based on the determined PRG size.

The techniques described herein may enable UEs 115 of the wireless communications system 100 to select and/or configure PRG sizes and sub-band precoding used for sidelink communications, thereby improving the efficiency and reliability of communications carried out over sidelink communication links.

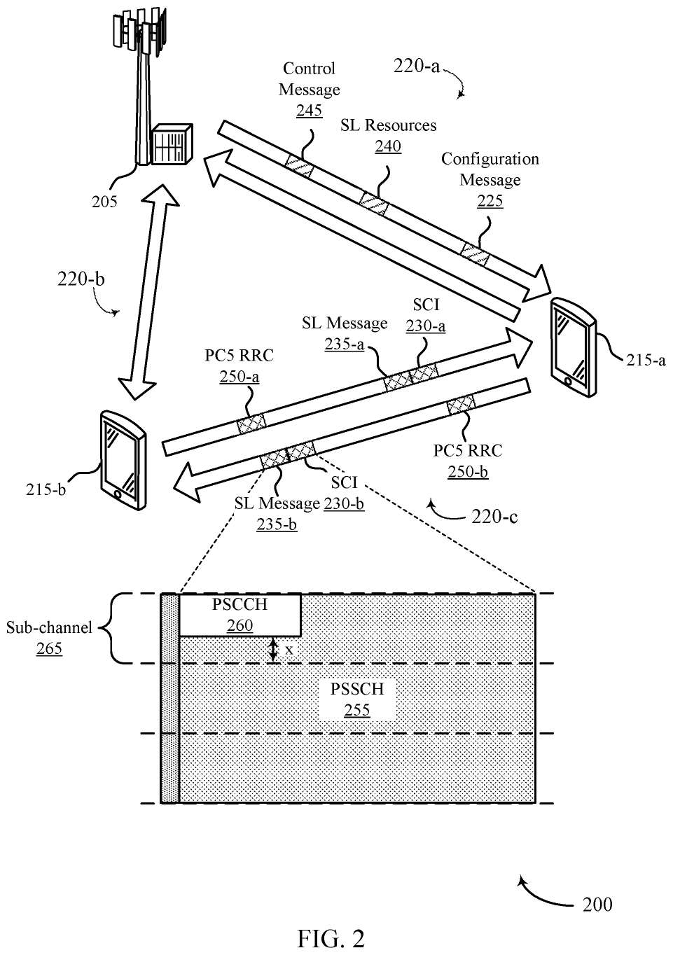

FIG. 2 illustrates an example of a wireless communications system 200 that supports techniques for sub-band precoding in sidelink communications in accordance with various aspects of the present disclosure. In some examples, wireless communications system 200 may implement aspects of wireless communications system 100. The wireless communications system 200 may include a first UE 215-a, a second UE 215-b, and a base station 205, which may be examples of UE 115 and base stations 105, as described with reference to FIG. 1. Wireless communications system 200 may support the signaling of PRG sizes between UEs 215 for sidelink communications, where such signaling may be static, semi-static, or dynamic, enabling efficient communications and increased flexibility for sidelink communications.

The first UE 215-a and the second UE 215-b may communicate with the base station 205 using a communication link 220-a and a communication link 220-b, respectively, which may be examples of an NR or LTE link between the first UE 115-a, the second UE 115-b, and the base station 105. In some cases, the communication link 220-a and the communication link 220-b may include examples of access links (e.g., Uu links). The communication link 220-a and communication link 220-b may include a bi-directional link that includes both uplink and downlink communication. For example, the first UE 215-a may transmit uplink signals, such as uplink control signals or uplink data signals, to the base station 205 using the first communication link 220-a and the base station 205 may transmit downlink signals, such as downlink control signals or downlink data signals, to the first UE 215-a using the communication link 220-a. By way of another example, the second UE 215-b may transmit uplink signals, such as uplink control signals or uplink data signals, to the base station 205 using the first communication link 220-b and the base station 205 may transmit downlink signals, such as downlink control signals or downlink data signals, to the second UE 215-b using the communication link 220-b. The first UE 215-a and the second UE 215-b may communicate with one another via a communication link 220-c. In some cases, the communication link 220-c may include an example of a link between two UEs 215 (e.g., a sidelink or PC5 link).

As noted previously herein, access links (e.g., Uu links) in some wireless communications systems may support both wideband precoding and sub-band precoding. Sub-band precoding and sub-band channel state information (CSI) reporting for access links may enable informed decisions about which precoders to use. In some cases, wideband precoding may result in improved performance. However, in other cases, sub-band precoding using varying sizes of PRGs may provide improved performance over wideband precoding. In this regard, the ability to modify a precoding scheme (e.g., wideband precoding, sub-band precoding) in the context of access links may provide for improved flexibility and performance. However, in the context of sidelink communications, only wideband precoding and wideband CSI reporting may be supported.

Accordingly, techniques of the present disclosure may support communications which enable wideband precoding and sub-band precoding in the context of wireless communications. The first UE 215-a, the second UE 215-b, and the base station 205 of the wireless communications system 200 may support techniques for sub-band precoding in sidelink communications. As an example, the wireless communications system 200 provide for signaling PRG sizes for sidelink communications such that sub-band precoding may be used for sidelink communications (in addition to wideband precoding). For the purposes of the present disclosure, the term “PRG” may be used to refer to a group of RBs within a message or signal (e.g., 5G message, NR message, LTE message, 4G message, 3G message, 2G message) which may be transmitted with a common precoder. In this regard, the term “PRG size” may refer to a frequency bandwidth, quantity of RBs, or both, which make up a PRG. For example, the PRG size of a PRG may be two RBs, four RBs, an entire allocated bandwidth (e.g., wideband precoding), and the like. In some cases, a PRG may be transmitted by a UE 215, base station 205, or other transmitting device using a common precoder. For example, a first PRG may be transmitted by a UE 215 using a first precoder, and a second PRG may be transmitted by the UE 215 using a second precoder different from the first precoder.

In some aspects, the first UE 215-a of the wireless communications system 200 may determine a PRG size for sidelink communications with the second UE 215-b dynamically based on indications within SCI including an MCS index, a dedicated bit field, or any combination thereof. Additionally or alternatively, the first UE 215-a may determine the PRG size for sidelink communications with the second UE 215-b statically or semi-statically based on RRC signaling, pre-configured PRG sizes associated with a resource pool allocated for a PSSCH, a determined sub-channel size, a quantity of sub-channels, or any combination thereof.

For example, the first UE 215-a may receive a configuration message 225 from the base station 205, the second UE 215-b, an additional UE 215, or any combination thereof. In some aspects, the configuration message 225 may indicate one or more PRG sizes for communications over the sidelink communication link (e.g., communication link 220-c) between the first UE 215-a and the second UE 215-b.

The first UE 215-a may additionally or alternatively receive a first SCI 230-a from the second UE 215-b. The first SCI 230-a may include SCI-1. In some aspects, the first SCI 230-a (e.g., SCI-1) may include decoding information for decoding additional SCI 230 (e.g., SCI-2). In some aspects, the second UE 215-b may transmit the first SCI 230-a to the first UE 215-a over the sidelink communication link (e.g., PC5 link, communication link 220-c) between the first UE 215-a and the second UE 215-b. In some aspects, the first SCI 230-a may indicate a first PRG size for communications over the sidelink communication link between the first UE 215-a and the second UE 215-b. Additionally or alternatively, the first SCI 230-a received by the first UE 215-a may include one or more indications which may be associated with the first PRG size for sidelink communications including an MCS index, a bit value, an SCI format, a target code rate, or any combination thereof. By way of another example, the first SCI 230-a may include an indication of an SCI rate-matching index (e.g., an index used to determine a number of modulation symbols for SCI). For instance, the SCI rate matching index may include a beta offset value which may be used to calculate a number of modulation symbols used for subsequent SCI (e.g., SCI-2) after rate matching and modulation.

In some aspects, the first UE 215-a may identify an MCS index for communications over the sidelink communication link between the first UE 215-a and the second UE 215-b (e.g., communication link 220-c) based on the first SCI 230-a. For example, the first UE 215-a may determine the first PRG size based on the MCS index indicated in the first SCI 230-a. The first UE 215-c may determine the first PRG size based on the MCS index satisfying one or more thresholds. For instance, the first UE 215-a may determine the first PRG size to be a first value if the MCS index is below a given threshold, and may determine the first PRG size to be a second value if the MCS index is above the given threshold. The first UE 215-a may determine the first PRG size to be a first size if a modulation indicated by the MCS index is below a given threshold, and may determine the first PRG size to be a second size if the modulation indicated by the MCS index is above the given threshold. The first UE 215-a may be configured to compare the MCS index to one or more thresholds in order to determine the first PRG size. In some aspects, an MCS index above or below a given threshold may indicate a wideband precoding scheme. Conversely, an MCS index above or below a given threshold may indicate a sub-band precoding scheme.

By way of another example, the first UE 215-a determine one or more indications of the first PRG size based on the first SCI 230-a. The one or more indications of the first PRG size indicated in the first SCI may include a bit value, an SCI format, an SCI rate-matching offset (e.g., beta offset), a target code rate, a sub-channel 265 size, a bandwidth part (BWP), a PDCCH REG bundling size, a demodulation reference signal (DMRS) pattern, or any combination thereof. For example, the first UE 215-a may determine the bit value, the MCS index, the SCI format, the SCI rate-matching offset (e.g., beta offset), the target code rate, or any combination thereof, based on the first SCI 230-a. In this example, the first UE 215-a may determine the first PRG size for sidelink communications with the second UE 215-b based on the determined bit value, the MCS index, the SCI format, the SCI rate-matching offset (e.g., beta offset), the target code rate, or any combination thereof.

In some aspects, the first UE 215-a may additionally or alternatively determine the first PRG size for sidelink communications with the second UE 215-b based on the configuration message 225 received from the base station 205, the second UE 215-b, an additional UE 215, or any combination thereof. For example, as noted previously herein, the configuration message 225 may indicate one or more PRG sizes for communications over the sidelink communication link between the first UE 215-a and the second UE 215-b. In this example, the first UE 215-a may determine the first PRG size based on the one or more PRG sizes indicated in the configuration message 225. In some examples, the configuration message may be received from another UE 215 via RRC signaling (e.g., within a PC5 RRC message).

In some aspects, the first UE 215-a may determine the first PRG size based on both the configuration message 225 and the first SCI 230-a. For example, the configuration message 225 may include an indication that an MCS value above a given threshold is associated with a first value for the first PRG size, and an MCS value below the given threshold is associated with a second value for the first PRG size. Subsequently, the first UE 215-a may determine the PRG size based on the indications provided in the configuration message 225 and an indication of the MCS value received in the first SCI 230-a. In this regard, the first UE 215-a may be at least partially preconfigured to determine the first PRG size. Accordingly, the first UE 215-a may determine the first PRG size dynamically based on the configuration message 225, the first SCI 230-a, or any combination thereof.

In some aspects, first UE 215-a may receive a sidelink message 235-a from the second UE 215-b via the sidelink communication link (e.g., communication link 220-c) between the first UE 215-a and the second UE 215-b. In some aspects, the first UE 215-a may receive the sidelink message 235-a based on the determined PRG size. For example, the first UE 215-a may decode the sidelink message 235-a based at least in part on the determined PRG size. For instance, the first UE 215-a may determine a wideband precoding scheme or a sub-band precoding scheme including one or more precoders used for sidelink communications with the second UE 215-b based on the PRG size, and may decode the sidelink message 235-a based on the determined wideband precoding scheme or the sub-band precoding scheme.

Similarly, the first UE 215-a may transmit a sidelink message 235-b to the second UE 215-b via the sidelink communication link (e.g., communication link 220-c) between the first UE 215-a and the second UE 215-b. In some aspects, the first UE 215-a may transmit the sidelink message 235-b based on the determined PRG size. For example, the first UE 215-a may precode the sidelink message 235-b based at least in part on the determined PRG size. For instance, the first UE 215-a may determine one or more precoders for transmitting the sidelink message 235-b based on the determined PRG size, and may transmit the sidelink message 235-b based on (e.g., using) the one or more precoders. In some aspects, the first UE 115-a may determine an indication of a wideband precoding scheme or a sub-band precoding scheme based on the determined PRG size, and may transmit the sidelink message 235-b based on the determined wideband precoding scheme or the determined sub-band precoding scheme.

These techniques may enable the first UE 215-a to determine a PRG size for sidelink communications statically or dynamically via signaling from the base station 105 (e.g., configuration message 225), signaling from another UE 215 (e.g., first SCI 230-a, a configuration message, a control message), or any combination thereof.

In additional or alternative aspects, the first UE 215-a may be configured to determine the PRG size statically or semi-statically. For example, in some cases, the first UE 215-a may receive an indication of one or more sets of resources (e.g., sidelink resources 240) allocated for communications over the first sidelink communication link (e.g., communication link 220-c) between the first UE 215-a and the second UE 215-b. The first UE 115-a may receive the indication of the one or more sets of resources allocated for communications over the first sidelink communication link (e.g., communication link 220-c) from the base station 205, the second UE 215-b, an additional UE 215, or any combination thereof. For example, the base station 205 may transmit a sidelink grant including an indication of one or more sets of resources (e.g., sidelink resources 240) allocated for communications over the first sidelink communication link between the first UE 215-a and the second UE 215-b. The one or more sets of resources may include time resources, frequency resources, or both, associated with sidelink communications.

The first UE 215-a may additionally or alternatively receive a control message 245 from the base station 205, the second UE 215-b, an additional UE 215, or any combination thereof. In some aspects, the control message 245 may include an indication of a sub-channel bandwidth associated with the first sidelink communication link between the first UE 215-a and the second UE 215-b, an indication quantity of sub-channels associated with the first sidelink communication link between the first UE 215-a and the second UE 215-b, or both.

In some aspects, the first UE 215-a may receive RRC signaling 250-a (e.g., PC5 RRC signaling) from the second UE 215-b. In some aspects, the RRC signaling 250-a received from the second UE 215-b may indicate the first PRG size associated with sidelink communications over the first sidelink communication link (e.g., communication link 220-c) between the first UE 215-a and the second UE 215-b.

The first UE 215-a may identify a sidelink configuration for sidelink communications with the second UE 115-b based on the indication of the sidelink resources 240, the control message 245, the RRC signaling 250-a, or any combination thereof. Identifying the sidelink configuration may include identifying one or more characteristics associated with the first sidelink communication link between the first UE 215-a and the second UE 215-b. The one or more characteristics may include time/frequency resources associated with sidelink communications, a PRG size associated with sidelink communications, and the like. The first UE 215-a may determine a first PRG size associated with sidelink communications over the first sidelink communication link between the first UE 215-a and the second UE 215-b based on the identified sidelink configuration identified. In some aspects, the first UE 115-a may determine the first PRG size based on the indication of sidelink resources 240, the control message 245, the RRC signaling 250, or any combination thereof.

For example, the first UE 215-a may determine the first PRG size based on the indication of the one or more sets of resources (e.g., sidelink resources 240) allocated for the first sidelink communication link between the first UE 215-a and the second UE 215-b 420. In this regard, the first UE 215-a may be preconfigured to determine the first PRG size based on a resource pool associated with sidelink communications with the second UE 215-b (e.g., based on a sidelink grant for sidelink communications between the first UE 215-a and the second UE 215-b).

Additionally or alternatively, the first UE 215-a may determine the first PRG size based on the indication of the sub-channel bandwidth associated with the first sidelink communication link indicated within the control message 245. The first UE 215-a may determine the first PRG size based on the sub-channel bandwidth satisfying one or more thresholds. For instance, the first UE 215-a may determine the first PRG size to be a first value if the sub-channel bandwidth is below a given threshold, and may determine the first PRG size to be a second value if the sub-channel bandwidth is above the given threshold. The first UE 215-b may be configured to compare the sub-channel bandwidth to one or more thresholds in order to determine the first PRG size. In some aspects, a sub-channel bandwidth above or below a given threshold may indicate a wideband precoding scheme. Conversely, a sub-channel bandwidth above or below a given threshold may indicate a sub-band precoding scheme.

Similarly, by way of another example, the first UE 215-a may determine the first PRG size based on the indication of the quantity of sub-channels associated with the first sidelink communication link indicated within the control message 245. In some aspects, the first UE 215-a may determine the first PRG size based on the quantity of sub-channels satisfying one or more thresholds, as discussed previously herein.

In some aspects, the first UE 215-a may receive a sidelink message 235-a from the second UE 215-b via the first sidelink communication link between the first UE 215-a and the second UE 215-b. In some aspects, the first UE 215-a may receive the sidelink message 235-a based on the first PRG size determined based on the sidelink resources 240, the control message 245, the RRC signaling 250-a, or any combination thereof. For example, the first UE 215-a may decode the sidelink message 235-a based at least in part on the first PRG size. For instance, the first UE 215-a may determine a wideband precoding scheme or a sub-band precoding scheme including one or more precoders used for sidelink communications based on the first PRG size, and may decode the sidelink message 235-a based on the determined wideband precoding scheme or the sub-band precoding scheme.

Similarly, first UE 215-a may transmit a sidelink message 235-b to the second UE 215-b via the first sidelink communication link between the first UE 215-a and the second UE 215-b. In some aspects, the first UE 215-a may transmit the sidelink message 235-b based on the first PRG size. For example, the first UE 215-a may precode the sidelink message 235-b based at least in part on the first PRG size. For instance, the first UE 215-a may determine one or more precoders for transmitting the sidelink message 235-b based on the first PRG size, and may transmit the sidelink message 235-b based on (e.g., using) the one or more precoders. In some aspects, the first UE 215-a may determine an indication of a wideband precoding scheme or a sub-band precoding scheme based on the first PRG size, and may transmit the sidelink message 235-b based on the determined wideband precoding scheme or the determined sub-band precoding scheme.

In some aspects, the sets of PRGs within the sidelink message 235-a and the sidelink message 235-b may be arranged based on a first RB of a set of resources allocated for the respective sidelink message 235-a or sidelink message 235-b. For example, the set of PRGs within the sidelink message 235-a may be arranged (e.g., partitioned) starting from a lowest numbered RB in the set of resources allocated for a PSSCH 255 (e.g., over communication link 220-c) between the first UE 115-a and the second UE 115-b. Additionally or alternatively, the sets of PRGs within the sidelink message 235-a and the sidelink message 235-b may be arranged based on an RB associated with the respective sidelink message 235-a or sidelink message 235-b. For example, the set of PRGs within the sidelink message 235-a may be arranged (e.g., partitioned) starting from a lowest numbered RB in a CORESET (e.g., CORESET 0), for example, for broadcast transmissions. Additionally or alternatively, the set of PRGs may be partitioned starting from a common RB (e.g., RB 0), for example, for unicast transmissions.

As shown in FIG. 2, a sidelink communication link (e.g., communication link 220-c) may include a PSSCH 255 and a PSCCH 260. The PSSCH 255 and PSCCH 260 may be transmitted within the same slot. In some aspects, a set of frequency resources for the sidelink communication link may be divided into one or more sub-channels 265 within the frequency domain. In some cases, the PSCCH 260 may be limited to one sub-channel 265, where the PSSCH 255 may span multiple sub-channels 265. For example, in some cases, a size (e.g., frequency bandwidth) of the PSCCH 260 may be less than or equal to the size (e.g., frequency bandwidth) of a sub-channel 265. For instance, in some aspects, a size of the sub-channels 265 may be configured (e.g., pre-configured) to be 10 PRBs, 15 PRBs, 20 PRBs, 25 PRBs, 75 PRBs, 100 PRBs, or the like, where a size of the PSCCH 260 may be configured (e.g., pre-configured) to be 10 PRBs, 12 PRBs, 15 PRBs, 20 PRBs, 25 PRBs, or the like,

In some aspects, there may be a configured (e.g., preconfigured) relationship between a size of a PSCCH 260 of the sidelink communication link (e.g., communication link 220-c), the determined PRG size, a sub-channel 265 size of the sidelink communication link (e.g., communication link 220-c), or any combination thereof. For example, in some aspects, the PRG size may be equal to a sub-channel 265 bandwidth of a set of resources allocated for the respective sidelink message 235-a or sidelink message 235-b (e.g., PRG size is equal to a bandwidth of a sub-channel of the sidelink communication link). In some aspects, the PRG size may be equal to a predefined (e.g., preconfigured) value. For instance, the PRG size may be equal to a predefined value (e.g., 1 PRB) based on the PRG size being less than a bandwidth of a set of resources allocated for the respective sidelink message 235-a or sidelink message 235-b.

By way of another example, the PRG size may be equal to the bandwidth of the set of resources allocated for the respective sidelink message 235-a or the sidelink message 235-b. For instance, in the case of a wideband precoding scheme, the PRG size may be equal to the allocated PSSCH 255 bandwidth or the entire bandwidth of the sidelink communication link between the first UE 115-a and the second UE 115-b.

In additional or alternative aspects, the first UE 115-a may determine a bandwidth difference between a sub-channel 265 bandwidth and a PSCCH 260 bandwidth (e.g., PSCCH−sub-channel=x) for communications over the sidelink communication link (e.g., communication link 220-c) between the first UE 115-a and the second UE 115-b. In this example, the bandwidth difference (x) may be an integer multiple of PRG size. Additionally, the UE 115-a may be configured to determine the PRG size, the sub-channel 265 bandwidth, the PSCCH 260 bandwidth, or any combination thereof, based on the difference bandwidth (x) being an integer multiple of the PRG size. In configuring the difference bandwidth (x) to be an integer multiple of the PRG size, an integer number of PRGs and the PSCCH 260 may fit within the bandwidth of the sub-channel 265.

In some aspects, the potential configured relationships between a PSCCH 260 bandwidth of the sidelink communication link (e.g., communication link 220-c), the determined PRG size, the sub-channel 265 bandwidth of the sidelink communication link (e.g., communication link 220-c), or any combination thereof, may be implicitly determined by the first UE 115-a, the second UE 115-b, the base station 105, the network (e.g., the wireless communications system 200), or any combination thereof. The configurations or conditions may be indicated via signaling within the wireless communications system 200 (e.g., via SCI signaling, RRC signaling, configuration messages, control messages). In this regard, the various parameters/characteristics (e.g., PRG size, sub-channel 265 bandwidth, PSCCH 260 bandwidth) may be configured or satisfy a given condition, as described herein. In some aspects, deviations from a given condition or configuration may be treated as a violation or error case. Additionally, the PRG size may be selected from a set of two or more PRG sizes, for example, such that the selected PRG size is one that satisfies the condition or configuration.

The techniques described with respect to FIG. 2 may enable more efficient and reliable sidelink communications between the first UE 215-a and the second UE 215-b of the wireless communications system 200. For example, the techniques described herein may enable the first UE 215-a and the second UE 215-b to select and/or configure PRG sizes and sub-band precoding used for sidelink communications, thereby improving the efficiency and reliability of communications carried out over sidelink communication links.

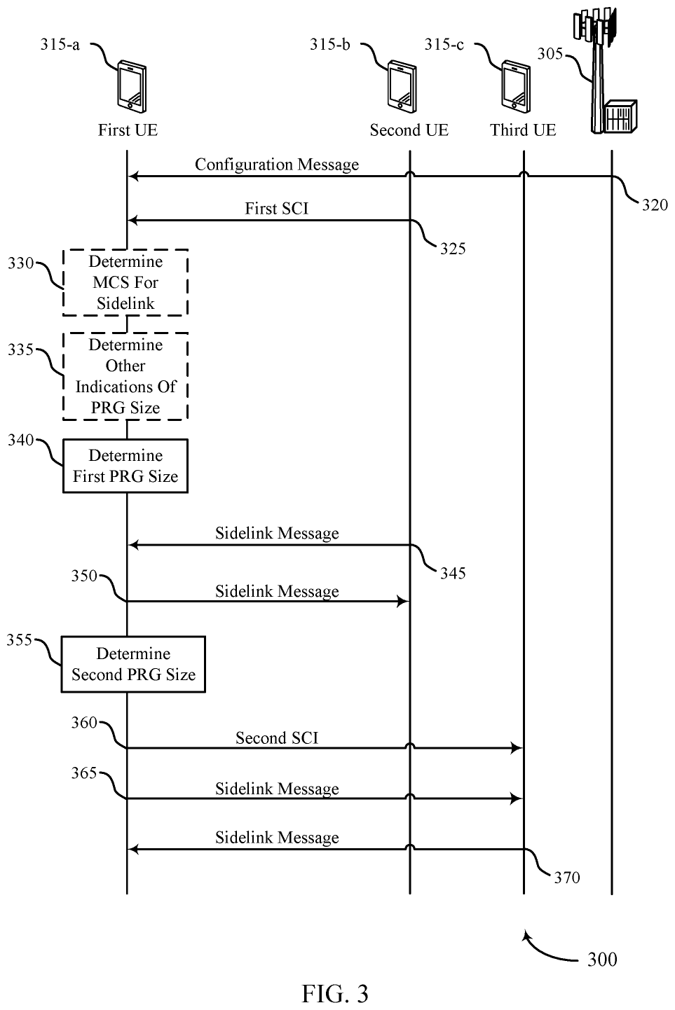

FIG. 3 illustrates an example of a process flow 300 that supports techniques for sub-band precoding in sidelink communications in accordance with various aspects of the present disclosure. In some examples, process flow 300 may implement aspects of wireless communications system 100 or 200. For example, the process flow 300 may illustrate receiving a configuration message and/or SCI, determining a first PRG size based on the configuration message, SCI, or both, and transmitting and receiving sidelink messages based on the determined first PRG size, as described with reference to FIGS. 1-2.

In some cases, process flow 300 may include a first UE 315-a, a second UE 315-a, a third UE 315-c, and a base station 305 which may be examples of corresponding devices as described herein. The first UE 315-a and the second UE 315-b illustrated in FIG. 3 may be examples of the first UE 215-a and the second UE 215-b, respectively, illustrated in FIG. 2. Similarly, the base station 305 illustrated in FIG. 3 may be an example of the base station 205 illustrated in FIG. 2. In some aspects, the first UE 315-a and the second UE 315-b may communicate over a first sidelink communication link, and the first UE 315-a and the third UE 315-c may communicate over a second sidelink communication link.

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 320, the first UE 315-a may receive a configuration message. For example, the UE 315 may receive the configuration message at 320 from the base station 305-b. However, in some aspects, the first UE 315-a may receive a configuration message from the second UE 315-a, the third UE 315-c, or any combination thereof. In some aspects, the configuration message may indicate one or more PRG sizes for communications over a sidelink communication link between the first UE 315-a and the second UE 315-b. In some aspects, the base station 305 may transmit the configuration message at 320 using the communication link 220-a as illustrated in FIG. 2.

At 325, the first UE 315-a may receive a first SCI from the second UE 315-d. The first SCI received at 325 may include SCI-1. In some aspects, the second UE 315-b may transmit the first SCI to the first UE 315-a over the first sidelink communication link communication link between the first UE 315-a and the second UE 315-b. For example, the second UE 315-b may transmit the first SCI at 325 using the communication link 220-c (e.g., sidelink or PC5 link) as illustrated in FIG. 2. In some aspects, the first SCI may indicate a first PRG size for communications over the first sidelink communication link between the first UE 315-a and the second UE 315-b.

Additionally or alternatively, the first SCI received by the first UE 315-a at 325 may include one or more indications which may be associated with the first PRG size for sidelink communications including an MCS index, a bit value, an SCI format, an SCI rate-matching offset (e.g., beta offset), a target code rate, or any combination thereof.

At 330, the first UE 315-a may identify an MCS index for communications over the sidelink communication link between the first UE 315-a and the second UE 315-b. In some aspects, the first UE 315-c may identify the MCS index based on the first SCI received at 325.

At 335, the first UE 315-a determine one or more indications of the first PRG size based on the first SCI received at 325. The one or more indications of the first PRG size indicated in the first SCI may include a bit value, an SCI format, an SCI rate-matching offset (e.g., an index used to determine a number of modulation symbols for SCI), a target code rate, or any combination thereof.

At 340, the first UE 315-a may determine a first PRG size for communications over the sidelink communication link between the first UE 315-a and the second UE 315-b. In some aspects, the first UE 315-a may determine the first PRG size based at least in part on the first SCI received at 325. For example, the first UE 315-a may determine the first PRG size based on the MCS index determined at 330. The first UE 315-c may determine the first PRG size based on the MCS index satisfying one or more thresholds. For instance, the first UE 315-a may determine the first PRG size to be a first value if the MCS index is below a given threshold, and may determine the first PRG size to be a second value if the MCS index is above the given threshold. The first UE 315-a may determine the first PRG size to be a first value if a modulation indicated by the MCS index is below a given threshold, and may determine the first PRG size to be a second value if the modulation indicated by the MCS index is above the given threshold. The first UE 315-b may be configured to compare the MCS index to one or more thresholds in order to determine the first PRG size. In some aspects, an MCS index above or below a given threshold may indicate a wideband precoding scheme. Conversely, an MCS index above or below a given threshold may indicate a sub-band precoding scheme.

By way of another example, the first UE 315-a may determine the first PRG size based on the one or more indications of the first PRG size determined at 315. For instance, the first UE 315-a may determine the first PRG size based on the bit value, the MCS index, the SCI format, the SCI rate-matching offset (e.g., beta offset), the target code rate, or any combination thereof.

In some aspects, the first UE 315-a may additionally or alternatively determine the first PRG size at 340 based on the configuration message received from the base station 305 at 320. For example, as noted previously herein, the configuration message may indicate one or more PRG sizes for communications over the sidelink communication link between the first UE 315-a and the second UE 315-b. In this example, the first UE 315-a may determine the first PRG size based on the one or more PRG sizes indicated in the configuration message.

In some aspects, the first UE 315-a may determine the first PRG size based on both the configuration message received at 320 and the first SCI received at 325. For example, the configuration message may include an indication that an MCS value above a given threshold is associated with a first value for the first PRG size, and an MCS value below the given threshold is associated with a second value for the first PRG size. Subsequently, the first UE 315-a may determine the PRG size based on the indications provided in the configuration message and an indication of the MCS value received in the first SCI. In this regard, the first UE 315-a may be at least partially preconfigured to determine the first PRG size. Accordingly, the first UE 315-a may determine the first PRG size based on the configuration message received at 320, the first SCI received at 325, or any combination thereof.

At 345, the first UE 315-a may receive a sidelink message from the second UE 315-b via the first sidelink communication link between the first UE 315-a and the second UE 315-b. In some aspects, the first UE 315-a may receive the sidelink message at 345 based on the first PRG size determined at 340. For example, the first UE 315-a may decode the sidelink message based at least in part on the first PRG size. For instance, the first UE 315-a may determine a wideband precoding scheme or a sub-band precoding scheme including one or more precoders used for sidelink communications based on the first PRG size determined at 340, and may decode the sidelink message received at 345 based on the determined wideband precoding scheme or the sub-band precoding scheme.

At 350, the first UE 315-a may transmit a sidelink message to the second UE 315-b via the first sidelink communication link between the first UE 315-a and the second UE 315-b. In some aspects, the first UE 315-a may transmit the sidelink message at 350 based on the first PRG size determined at 340. For example, the first UE 315-a may precode the sidelink message based at least in part on the first PRG size. For instance, the first UE 315-a may determine one or more precoders for transmitting the sidelink message at 350 based on the first PRG size, and may transmit the sidelink message at 350 based on (e.g., using) the one or more precoders. In some aspects, the first UE 315-a may determine an indication of a wideband precoding scheme or a sub-band precoding scheme based on the first PRG size, and may transmit the sidelink message at 350 based on the determined wideband precoding scheme or the determined sub-band precoding scheme.

At 355, the first UE 315-a may determine a second PRG size for communications over the second sidelink communication link between the first UE 315-a and the third UE 315-c. The first UE 315-a may determine the second PRG size for communications over the second sidelink communication link between the first UE 315-a and the third UE 315-c based on a received SCI, the configuration message received at 320, or any combination thereof.

At 360, the first UE 315-a may transmit a second SCI to the third UE 315-c. The second SCI transmitted at 360 may include SCI-1. In some aspects, the first UE 315-a may transmit the second SCI to the third UE 315-c over the second sidelink communication link between the first UE 315-a and the third UE 315-c. In some aspects, the second SCI may indicate a second PRG size for communications over the second sidelink communication link between the first UE 315-a and the third UE 315-c. Additionally or alternatively, the second SCI may include decoding information for decoding additional SCI (e.g., decoding information associated with SCI-2).

At 365, the first UE 315-a may transmit a sidelink message to the third UE 315-c via the second sidelink communication link between the first UE 315-a and the third UE 315-c. In some aspects, the first UE 315-a may transmit the sidelink message at 365 based on the second PRG size determined at 355, the second SCI transmitted at 360, or both. For example, the first UE 315-a may precode the sidelink message based at least in part on the second PRG size. For instance, the first UE 315-a may determine one or more precoders for transmitting the sidelink message at 365 based on the second PRG size, and may transmit the sidelink message at 365 based on (e.g., using) the one or more precoders. In some aspects, the first UE 315-a may determine an indication of a wideband precoding scheme or a sub-band precoding scheme based on the second PRG size, and may transmit the sidelink message at 365 based on the determined wideband precoding scheme or the determined sub-band precoding scheme.

At 370, the first UE 315-a may receive a sidelink message from the third UE 315-c via the second sidelink communication link between the first UE 315-a and the third UE 315-c. In some aspects, the first UE 315-a may receive the sidelink message at 370 based on the second PRG size determined at 355, the second SCI transmitted at 360, or both. For example, the first UE 315-a may decode the sidelink message based at least in part on the second PRG size. For instance, the first UE 315-a may determine a wideband precoding scheme or a sub-band precoding scheme including one or more precoders used for sidelink communications with the third UE 315-c based on the second PRG size determined at 355, and may decode the sidelink message received at 370 based on the determined wideband precoding scheme or the sub-band precoding scheme.

The techniques described with respect to FIG. 3 may enable more efficient and reliable sidelink communications between the first UE 315-a, the second UE 315-b, and the third UE 315-c. The techniques described herein may enable the first UE 315-a, the second UE 315-b, and the third UE 315-c to select and/or configure PRG sizes and sub-band precoding used for sidelink communications, thereby improving the efficiency and reliability of communications carried out over sidelink communication links.

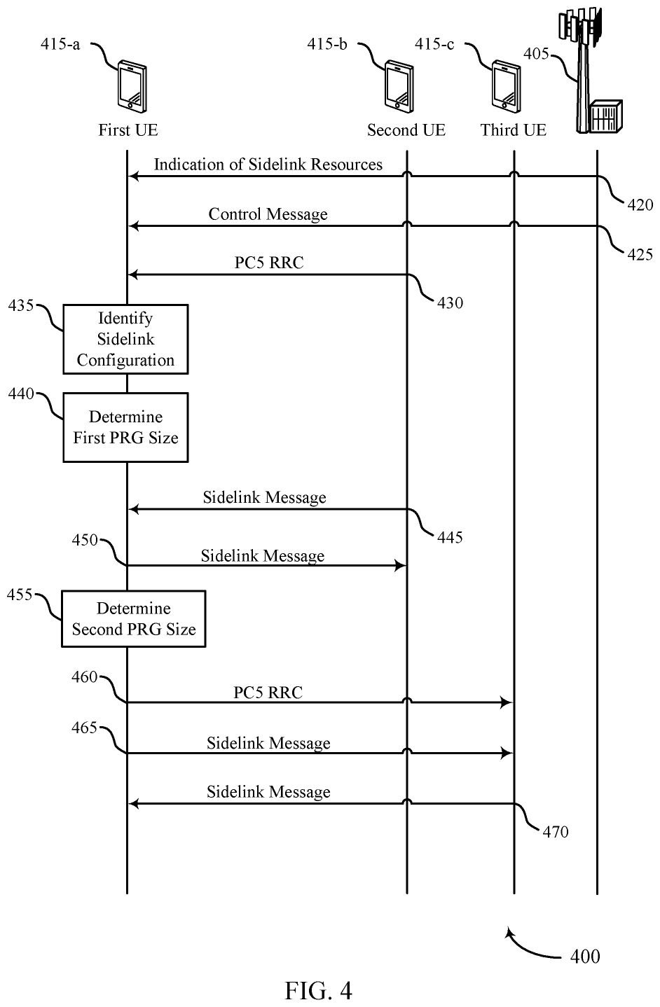

FIG. 4 illustrates an example of a process flow 400 that supports techniques for sub-band precoding in sidelink communications in accordance with various aspects of the present disclosure. In some examples, process flow 400 may implement aspects of wireless communications system 100, wireless communications system 200, and process flow 300. For example, the process flow 400 may illustrate establishing a connection with a first cell, performing a setup procedure with a second cell, receiving a configuration message indicating a deactivation of an EPS bearer, updating a counter value, and detaching from the first cell based on the counter satisfying a threshold counter value, as described with reference to FIGS. 1-3.

In some cases, process flow 400 may include a first UE 415-a, a second UE 415-b, a third UE 415-c, and a base station 405 which may be examples of corresponding devices as described herein. The first UE 415-a and the second UE 415-b illustrated in FIG. 4 may be examples of the first UE 415-a and the second UE 415-b, respectively, illustrated in FIG. 2 or 3. Similarly, the base station 405 illustrated in FIG. 4 may be an example of the base station 405 illustrated in FIG. 2 or 3. In some aspects, the first UE 415-a and the second UE 415-b may communicate over a first sidelink communication link, and the first UE 415-a and the third UE 415-c may communicate over a second sidelink communication link.

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 420, the first UE 415-a may receive an indication of one or more sets of resources allocated for communications over the first sidelink communication link between the first UE 415-a and the second UE 415-b or the second sidelink communication link between the first UE 415-a and the third UE 415-c. The first UE 415-a may receive the indication of the one or more sets of resources allocated for communications over the first sidelink communication link or the second sidelink communication link from the base station 405, the second UE 415-b, the third UE 415-c, or any combination thereof. For example, the base station 405 may transmit a sidelink grant including an indication of one or more sets of resources allocated for communications over the first sidelink communication link between the first UE 415-a and the second UE 415-b. The one or more sets of resources may include time resources, frequency resources, or both, associated with sidelink communications.

At 425, the first UE 415-a may receive a control message 405. The first UE 215-a may receive the control message from the base station 405 (as illustrated in FIG. 4), the second UE 415-a, the third UE 415-c, or any combination thereof. In some aspects, the control message may include an indication of a sub-channel bandwidth associated with the first sidelink communication link between the first UE 415-a and the second UE 415-b or the second sidelink communication link between the first UE 415-a and the third UE 415-c. Additionally or alternatively, the control message may include an indication quantity of sub-channels associated with the first sidelink communication link between the first UE 415-a and the second UE 415-b or the second sidelink communication link between the first UE 415-a and the third UE 415-c.

At 430, the first UE 415-a may receive RRC signaling (e.g., PC5 RRC signaling) from the second UE 415-b. In some aspects, the RRC signaling received at 430 may indicate the first PRG size associated with sidelink communications over the first sidelink communication link between the first UE 415-a and the second UE 415-b.

At 435, the first UE 415-a may identify a sidelink configuration for sidelink communications with the second UE 415-b, the third UE 415-b, or both. Identifying the sidelink configuration at 435 may include identifying one or more characteristics associated with the first sidelink communication link between the first UE 415-a and the second UE 415-b or the second sidelink communication link between the first UE 415-a and the third UE 415-c. The one or more characteristics may include time/frequency resources associated with sidelink communications, a PRG size associated with sidelink communications, and the like.

At 440, the first UE 415-a may determine a first PRG size associated with sidelink communications over the first sidelink communication link between the first UE 415-a and the second UE 415-b. In some aspects, the first UE 415-a may determine the first PRG size based on the sidelink configuration identified at 435. In some aspects, the first UE 415-a may determine the first PRG size based on the indication of sidelink resources received at 420, the control message received at 425, the RRC signaling received at 430, or any combination thereof.

For example, the first UE 415-a may determine the first PRG size based on the indication of the one or more sets of resources allocated for the first sidelink communication link between the first UE 415-a and the second UE 415-b received at 420. In this regard, the first UE 415-a may be preconfigured to determine the first PRG size based on a resource pool associated with sidelink communications with the second UE 415-b (e.g., based on a sidelink grant for sidelink communications between the first UE 415-a and the second UE 415-b).

Additionally or alternatively, the first UE 415-a may determine the first PRG size based on the indication of the sub-channel bandwidth associated with the first sidelink communication link received via the control message at 425. The first UE 415-a may determine the first PRG size based on the sub-channel bandwidth satisfying one or more thresholds. For instance, the first UE 415-a may determine the first PRG size to be a first value if the sub-channel bandwidth is below a given threshold, and may determine the first PRG size to be a second value if the sub-channel bandwidth is above the given threshold. The first UE 415-b may be configured to compare the sub-channel bandwidth to one or more thresholds in order to determine the first PRG size. In some aspects, a sub-channel bandwidth above or below a given threshold may indicate a wideband precoding scheme. Conversely, a sub-channel bandwidth above or below a given threshold may indicate a sub-band precoding scheme.

Similarly, by way of another example, the first UE 415-a may determine the first PRG size based on the indication of the quantity of sub-channels associated with the first sidelink communication link received via the control message at 425. In some aspects, the first UE 415-a may determine the first PRG size based on the quantity of sub-channels satisfying one or more thresholds, as discussed previously herein.

At 445, the first UE 415-a may receive a sidelink message from the second UE 415-b via the first sidelink communication link between the first UE 415-a and the second UE 415-b. In some aspects, the first UE 415-a may receive the sidelink message at 445 based on the first PRG size determined at 440. For example, the first UE 415-a may decode the sidelink message based at least in part on the first PRG size. For instance, the first UE 415-a may determine a wideband precoding scheme or a sub-band precoding scheme including one or more precoders used for sidelink communications based on the first PRG size determined at 440, and may decode the sidelink message received at 445 based on the determined wideband precoding scheme or the sub-band precoding scheme.

At 450, the first UE 415-a may transmit a sidelink message to the second UE 415-b via the first sidelink communication link between the first UE 415-a and the second UE 415-b. In some aspects, the first UE 415-a may transmit the sidelink message at 450 based on the first PRG size determined at 440. For example, the first UE 415-a may precode the sidelink message based at least in part on the first PRG size. For instance, the first UE 415-a may determine one or more precoders for transmitting the sidelink message at 450 based on the first PRG size, and may transmit the sidelink message at 450 based on (e.g., using) the one or more precoders. In some aspects, the first UE 415-a may determine an indication of a wideband precoding scheme or a sub-band precoding scheme based on the first PRG size, and may transmit the sidelink message at 450 based on the determined wideband precoding scheme or the determined sub-band precoding scheme.

At 455, the first UE 415-a may determine a second PRG size for communications over the second sidelink communication link between the first UE 415-a and the third UE 415-c. The first UE 415-a may determine the second PRG size for communications over the second sidelink communication link between the first UE 415-a and the third UE 415-c based on a received SCI, received PC5 RRC signaling, a received configuration message, the indication of sidelink resources received at 420, the control message received at 425, or any combination thereof.

At 460, the first UE 415-a may transmit a PC5 RRC signaling to the third UE 415-c. In some aspects, the first UE 415-a may transmit the PC5 RRC signaling to the third UE 415-c over the second sidelink communication link between the first UE 415-a and the third UE 415-c. In some aspects, the PC5 RRC signaling may indicate a second PRG size for communications over the second sidelink communication link between the first UE 415-a and the third UE 415-c.

At 465, the first UE 415-a may transmit a sidelink message to the third UE 415-c via the second sidelink communication link between the first UE 415-a and the third UE 415-c. In some aspects, the first UE 415-a may transmit the sidelink message at 365 based on the second PRG size determined at 355, the PC5 RRC signaling transmitted at 460, or both. For example, the first UE 415-a may precode the sidelink message based at least in part on the second PRG size. For instance, the first UE 415-a may determine one or more precoders for transmitting the sidelink message at 465 based on the second PRG size, and may transmit the sidelink message at 465 based on (e.g., using) the one or more precoders. In some aspects, the first UE 415-a may determine an indication of a wideband precoding scheme or a sub-band precoding scheme based on the second PRG size, and may transmit the sidelink message at 465 based on the determined wideband precoding scheme or the determined sub-band precoding scheme.

At 470, the first UE 415-a may receive a sidelink message from the third UE 415-c via the second sidelink communication link between the first UE 415-a and the third UE 415-c. In some aspects, the first UE 415-a may receive the sidelink message at 370 based on the second PRG size determined at 455, the PC5 RRC signaling transmitted at 460, or both. For example, the first UE 415-a may decode the sidelink message based at least in part on the second PRG size. For instance, the first UE 415-a may determine a wideband precoding scheme or a sub-band precoding scheme including one or more precoders used for sidelink communications with the third UE 415-c based on the second PRG size determined at 455, and may decode the sidelink message received at 470 based on the determined wideband precoding scheme or the sub-band precoding scheme.

The techniques described with respect to FIG. 4 may enable more efficient and reliable sidelink communications between the first UE 415-a, the second UE 415-b, and the third UE 415-c. The techniques described herein may enable the first UE 415-a, the second UE 415-b, and the third UE 415-c to select and/or configure PRG sizes and sub-band precoding used for sidelink communications, thereby improving the efficiency and reliability of communications carried out over sidelink communication links.

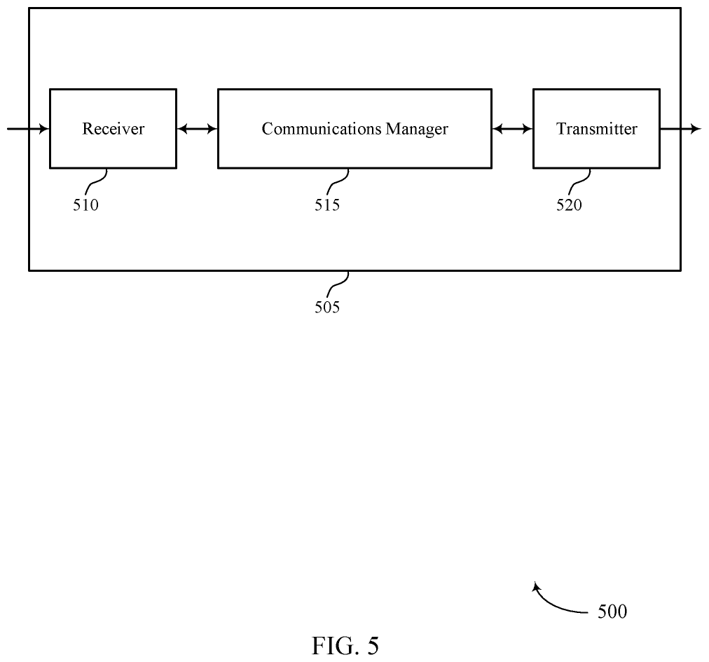

FIG. 5 shows a block diagram 500 of a device 505 that supports techniques for sub-band precoding in sidelink communications in accordance with various aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

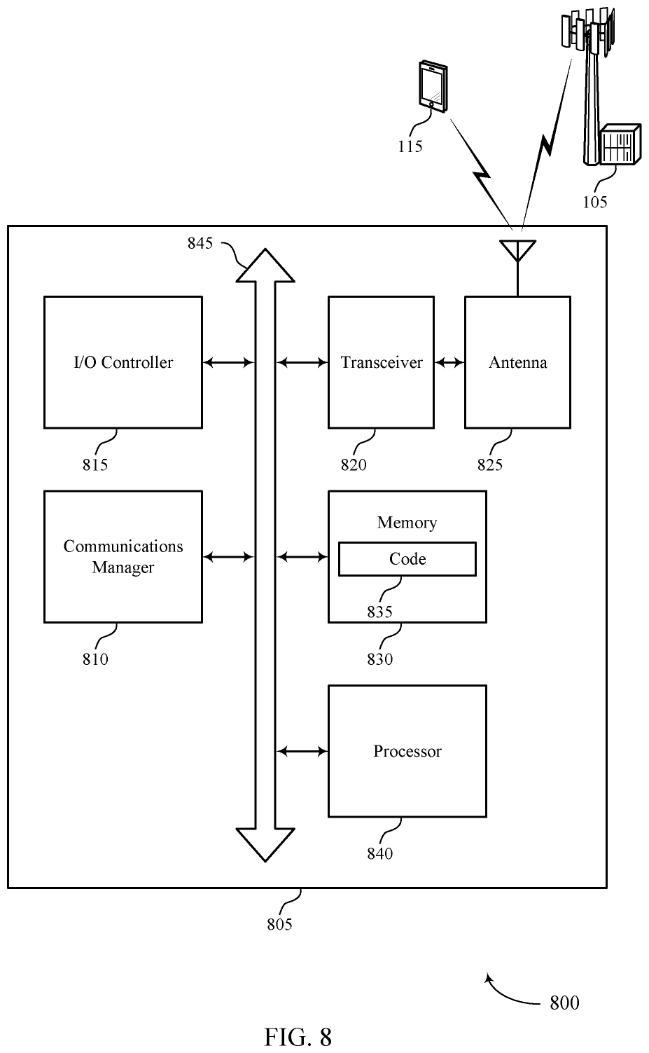

The receiver 510 may receive information such as packets, user data, or control information associated with various information channels (e.g., control channels, data channels, and information related to techniques for sub-band precoding in sidelink communications, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may receive, from a second UE, SCI over a sidelink communication link between the first UE and the second UE, the SCI indicating a PRG size, determine the PRG size for communications over the sidelink communication link based on the SCI, and receive, from the second UE, a sidelink message via the sidelink communication link based on the determined PRG size. The communications manager 515 may also identify a sidelink configuration for a sidelink communication link between the first UE and a second UE, determine a PRG size for communications over the sidelink communication link based on the sidelink configuration, and receive, from the second UE, a sidelink message based on the PRG size. The communications manager 515 may be an example of aspects of the communications manager 810 described herein.

The actions performed by the communications manager 515 as described herein may be implemented to realize one or more potential advantages. For example, enabling a UE 115 to select or configure PRG sizes and sub-band precoding (in addition to wideband precoding) may improve the efficiency and reliability of wireless communications, thereby improving user experience.

By enabling a UE 115 to s or configure PRG sizes and sub-band precoding (in addition to wideband precoding), a processor of the UE 115 (e.g., a processor controlling the receiver 510, the communications manager 515, the transmitter 520, etc.) may reduce processing resources used for sidelink communications. For example, by improving efficiency and reliability of sidelink communications, the UE 115 may reduce the number of retransmissions used to successfully transmit and receive sidelink messages at a UE 115, correspondingly reducing a number of times the processor ramps up processing power and turns on processing units to handle sidelink message transmission and reception.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver component. For example, the transmitter 520 may be an example of aspects of the transceiver 820 described with reference to FIG. 8. The transmitter 520 may utilize a single antenna or a set of antennas.

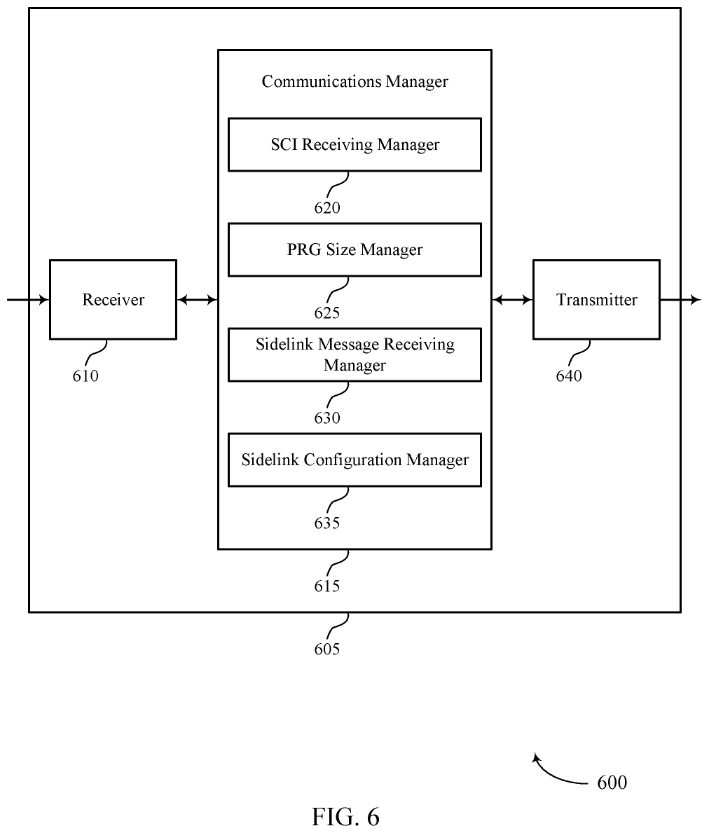

FIG. 6 shows a block diagram 600 of a device 605 that supports techniques for sub-band precoding in sidelink communications in accordance with various aspects of the present disclosure. The device 605 may be an example of aspects of a device 505, or a UE 115 as described herein. The device 605 may include a receiver 610, a communications manager 615, and a transmitter 640. The device 605 may also include a processor. Each of these components may be in communication with one another (e.g., via one or more buses).

The receiver 610 may receive information such as packets, user data, or control information associated with various information channels (e.g., control channels, data channels, and information related to techniques for sub-band precoding in sidelink communications, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a SCI receiving manager 620, a PRG size manager 625, a sidelink message receiving manager 630, and a sidelink configuration manager 635. The communications manager 615 may be an example of aspects of the communications manager 810 described herein.

The SCI receiving manager 620 may receive, from a second UE, SCI over a sidelink communication link between the first UE and the second UE, the SCI indicating a PRG size. The PRG size manager 625 may determine the PRG size for communications over the sidelink communication link based on the SCI.

The sidelink message receiving manager 630 may receive, from the second UE, a sidelink message via the sidelink communication link based on the determined PRG size. The sidelink configuration manager 635 may identify a sidelink configuration for a sidelink communication link between the first UE and a second UE. The PRG size manager 625 may determine a PRG size for communications over the sidelink communication link based on the sidelink configuration. The sidelink message receiving manager 630 may receive, from the second UE, a sidelink message based on the PRG size.

The transmitter 640 may transmit signals generated by other components of the device 605. In some examples, the transmitter 640 may be collocated with a receiver 610 in a transceiver component. For example, the transmitter 640 may be an example of aspects of the transceiver 820 described with reference to FIG. 8. The transmitter 640 may utilize a single antenna or a set of antennas.

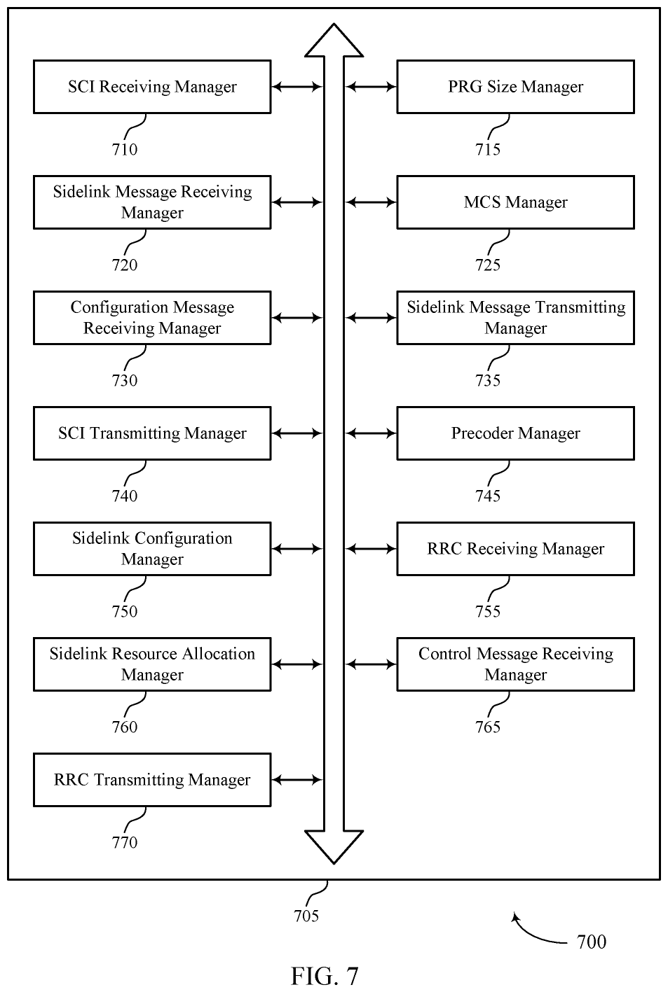

FIG. 7 shows a block diagram 700 of a communications manager 705 that supports techniques for sub-band precoding in sidelink communications in accordance with various aspects of the present disclosure. The communications manager 705 may be an example of aspects of a communications manager 515, a communications manager 615, or a communications manager 810 described herein. The communications manager 705 may include a SCI receiving manager 710, a PRG size manager 715, a sidelink message receiving manager 720, a MCS manager 725, a configuration message receiving manager 730, a sidelink message transmitting manager 735, a SCI transmitting manager 740, a precoder manager 745, a sidelink configuration manager 750, a RRC receiving manager 755, a sidelink resource allocation manager 760, a control message receiving manager 765, and a RRC transmitting manager 770. Each of these components may communicate, directly or indirectly, with one another (e.g., via one or more buses).

The SCI receiving manager 710 may receive, from a second UE, SCI over a sidelink communication link between the first UE and the second UE, the SCI indicating a PRG size. The PRG size manager 715 may determine the PRG size for communications over the sidelink communication link based on the SCI.

In some examples, the PRG size manager 715 may determine a PRG size for communications over the sidelink communication link based on the sidelink configuration. In some examples, the PRG size manager 715 may determine the PRG size based on the modulation and coding scheme index satisfying one or more thresholds. In some examples, the PRG size manager 715 may determine a second PRG size for communications over a second sidelink communication link between the first UE and a third UE. In some examples, the PRG size manager 715 may determine a bandwidth difference between a sub-channel bandwidth and a physical sidelink control channel bandwidth for communications over the sidelink communication link. In some cases, the SCI indicates the PRG size via a bit value, a SCI format, a SCI rate-matching offset (e.g., beta offset), a target code rate, or any combination thereof, and where determining the PRG size is based on the bit value and a modulation and coding scheme index, the SCI format, the SCI rate-matching offset (e.g., beta offset), the target code rate, or any combination thereof.

In some examples, the PRG size manager 715 may determine one or more of the PRG size, the sub-channel bandwidth, or the physical sidelink control channel bandwidth based on the bandwidth difference being an integer multiple of the PRG size. In some examples, the PRG size manager 715 may determine that the PRG size is equal to a sub-channel bandwidth of a set of resources allocated for the sidelink message. In some examples, the PRG size manager 715 may determine that the PRG size is equal to a predefined value based on the PRG size being less than a bandwidth of a set of resources allocated for the sidelink message. In some examples, the PRG size manager 715 may determine that the PRG size is equal to a bandwidth of a set of resources allocated for the sidelink message. In some examples, the PRG size manager 715 may determine the PRG size based on the sub-channel bandwidth satisfying one or more thresholds. In some examples, the PRG size manager 715 may determine a second PRG size for communications over a second sidelink communication link between the first UE and a third UE.

In some examples, the PRG size manager 715 may determine a bandwidth difference between a sub-channel bandwidth and a physical sidelink control channel bandwidth for communications over the sidelink communication link. In some examples, the PRG size manager 715 may determine one or more of the PRG size, the sub-channel bandwidth, or the physical sidelink control channel bandwidth based on the bandwidth difference being an integer multiple of the PRG size. In some examples, the PRG size manager 715 may determine that the PRG size is equal to a sub-channel bandwidth of a set of resources allocated for the sidelink message. In some examples, the PRG size manager 715 may determine that the PRG size is equal to a predefined value based on the PRG size being less than a bandwidth of a set of resources allocated for the sidelink message.

In some cases, a set of PRGs of the sidelink message are arranged based on a first RB of a set of resources allocated for the sidelink message. In some cases, a set of PRGs of the sidelink message are arranged based on a sidelink common RB. In some cases, a set of PRGs of the sidelink message are arranged based on a first RB of a set of resources allocated for the sidelink message.

The sidelink message receiving manager 720 may receive, from the second UE, a sidelink message via the sidelink communication link based on the determined PRG size. In some examples, the sidelink message receiving manager 720 may receive, from the second UE, a sidelink message based on the PRG size. The sidelink configuration manager 750 may identify a sidelink configuration for a sidelink communication link between the first UE and a second UE.

The MCS manager 725 may identify, from the SCI, a modulation and coding scheme index for the communications over the sidelink communication link, where determining the PRG size is based on the modulation and coding scheme index.

The configuration message receiving manager 730 may receive, from a base station, a configuration message indicating one or more PRG sizes for communications over the sidelink communication link between the first UE and the second UE, where determining the PRG size is based on the one or more PRG sizes and the SCI.

The sidelink message transmitting manager 735 may transmit, to the second UE, a second sidelink message via the sidelink communication link based on determining the PRG size, where the second sidelink message is precoded based on the PRG size. In some examples, the sidelink message transmitting manager 735 may transmit, to the third UE, a second sidelink message via the second sidelink communication link based on transmitting the second SCI, where the second sidelink message is precoded based on the second PRG size. In some examples, the sidelink message transmitting manager 735 may transmit, to the second UE, a second sidelink message via the sidelink communication link based on the PRG size, where the second sidelink message is precoded based on the PRG size. In some examples, the sidelink message transmitting manager 735 may transmit, to the third UE, a second sidelink message via the second sidelink communication link based on transmitting the radio resource control signaling, where the second sidelink message is precoded based on the second PRG size.

The SCI transmitting manager 740 may transmit, to the third UE, a second SCI via the second sidelink communication link, the second SCI indicating the second PRG size.

The precoder manager 745 may determine one or more precoders for transmitting the second sidelink message based on the second PRG size, where transmitting the second sidelink message is based on determining the one or more precoders. In some examples, the precoder manager 745 may determine an indication of a wideband precoding scheme or sub-band precoding scheme for transmitting the second sidelink message based on the second PRG size.

The RRC receiving manager 755 may receive, from the second UE, radio resource control signaling indicating the PRG size, where the PRG size is determined based on the radio resource control signaling. The RRC transmitting manager 770 may transmit, to the third UE, radio resource control signaling via the second sidelink communication link, the radio resource control signaling indicating the second PRG size.

The sidelink resource allocation manager 760 may receive, from a base station, an indication of one or more sets of resources allocated for communications over the sidelink communication link, where determining the PRG size is based on the indication of the one or more sets of resources allocated for communications over the sidelink communication link.

The control message receiving manager 765 may receive, from a base station, a control message including an indication of a sub-channel bandwidth associated with the sidelink communication link, where determining the PRG size is based on the indication of the sub-channel bandwidth. In some examples, the control message receiving manager 765 may receive, from a base station, a control message including an indication of a quantity of sub-channels associated with the sidelink communication link, where determining the PRG size is based on the indication of the quantity of sub-channels associated with the sidelink communication link.

FIG. 8 shows a diagram of a system 800 including a device 805 that supports techniques for sub-band precoding in sidelink communications in accordance with various aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may receive, from a second UE, SCI over a sidelink communication link between the first UE and the second UE, the SCI indicating a PRG size, determine the PRG size for communications over the sidelink communication link based on the SCI, and receive, from the second UE, a sidelink message via the sidelink communication link based on the determined PRG size. The communications manager 810 may also identify a sidelink configuration for a sidelink communication link between the first UE and a second UE, determine a PRG size for communications over the sidelink communication link based on the sidelink configuration, and receive, from the second UE, a sidelink message based on the PRG size.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described herein. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas. In some cases, the wireless device may include a single antenna 825. However, in some cases the device may have more than one antenna 825, which may be capable of concurrently transmitting or receiving multiple wireless transmissions.

The memory 830 may include random-access memory (RAM) and read-only memory (ROM). The memory 830 may store computer-readable, computer-executable code 835 including instructions that, when executed, cause the processor to perform various functions described herein. In some cases, the memory 830 may contain, among other things, a basic I/O system (BIOS) which may control basic hardware or software operation such as the interaction with peripheral components or devices.

The processor 840 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for sub-band precoding in sidelink communications).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

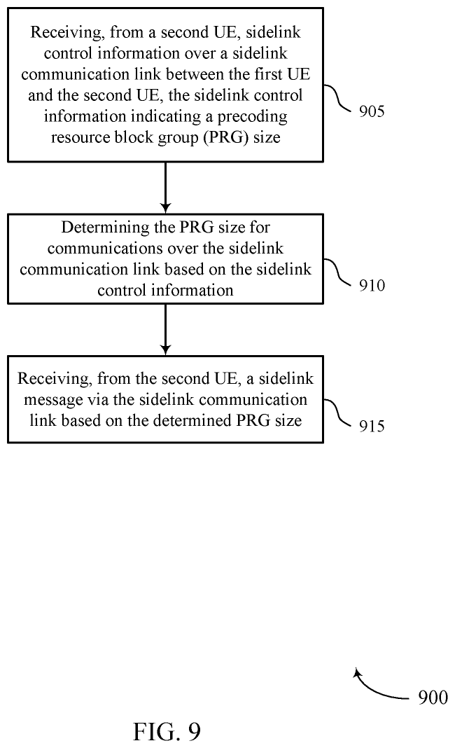

FIG. 9 shows a flowchart illustrating a method 900 that supports techniques for sub-band precoding in sidelink communications in accordance with various aspects of the present disclosure. The operations of method 900 may be implemented by a UE 115 or its components as described herein. For example, the operations of method 900 may be performed by a communications manager as described with reference to FIGS. 5 through 8. In some examples, a UE may execute a set of instructions to control the functional elements of the UE to perform the functions described herein. Additionally or alternatively, a UE may perform aspects of the functions described herein using special-purpose hardware.

At 905, the UE may receive, from a second UE, SCI over a sidelink communication link between the first UE and the second UE, the SCI indicating a PRG size. The operations of 905 may be performed according to the methods described herein. In some examples, aspects of the operations of 905 may be performed by a SCI receiving manager as described with reference to FIGS. 5 through 8.

At 910, the UE may determine the PRG size for communications over the sidelink communication link based on the SCI. The operations of 910 may be performed according to the methods described herein. In some examples, aspects of the operations of 910 may be performed by a PRG size manager as described with reference to FIGS. 5 through 8.

At 915, the UE may receive, from the second UE, a sidelink message via the sidelink communication link based on the determined PRG size. The operations of 915 may be performed according to the methods described herein. In some examples, aspects of the operations of 915 may be performed by a sidelink message receiving manager as described with reference to FIGS. 5 through 8.

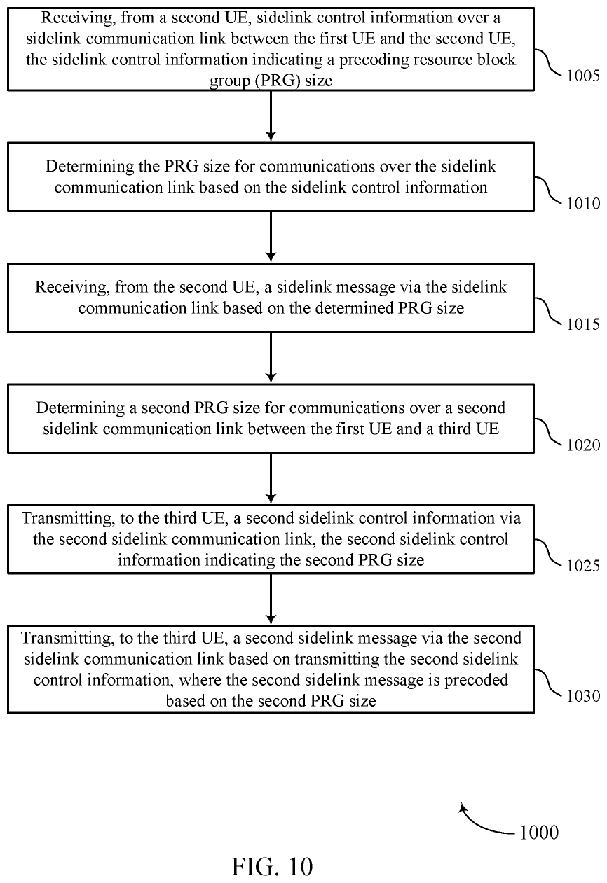

FIG. 10 shows a flowchart illustrating a method 1000 that supports techniques for sub-band precoding in sidelink communications in accordance with various aspects of the present disclosure. The operations of method 1000 may be implemented by a UE 115 or its components as described herein. For example, the operations of method 1000 may be performed by a communications manager as described with reference to FIGS. 5 through 8. In some examples, a UE may execute a set of instructions to control the functional elements of the UE to perform the functions described herein. Additionally or alternatively, a UE may perform aspects of the functions described herein using special-purpose hardware.

At 1005, the UE may receive, from a second UE, SCI over a sidelink communication link between the first UE and the second UE, the SCI indicating a PRG size. The operations of 1005 may be performed according to the methods described herein. In some examples, aspects of the operations of 1005 may be performed by a SCI receiving manager as described with reference to FIGS. 5 through 8.

At 1010, the UE may determine the PRG size for communications over the sidelink communication link based on the SCI. The operations of 1010 may be performed according to the methods described herein. In some examples, aspects of the operations of 1010 may be performed by a PRG size manager as described with reference to FIGS. 5 through 8.

At 1015, the UE may receive, from the second UE, a sidelink message via the sidelink communication link based on the determined PRG size. The operations of 1015 may be performed according to the methods described herein. In some examples, aspects of the operations of 1015 may be performed by a sidelink message receiving manager as described with reference to FIGS. 5 through 8.

At 1020, the UE may determine a second PRG size for communications over a second sidelink communication link between the first UE and a third UE. The operations of 1020 may be performed according to the methods described herein. In some examples, aspects of the operations of 1020 may be performed by a PRG size manager as described with reference to FIGS. 5 through 8.

At 1025, the UE may transmit, to the third UE, a second SCI via the second sidelink communication link, the second SCI indicating the second PRG size. The operations of 1025 may be performed according to the methods described herein. In some examples, aspects of the operations of 1025 may be performed by a SCI transmitting manager as described with reference to FIGS. 5 through 8.

At 1030, the UE may transmit, to the third UE, a second sidelink message via the second sidelink communication link based on transmitting the second SCI, where the second sidelink message is precoded based on the second PRG size. The operations of 1030 may be performed according to the methods described herein. In some examples, aspects of the operations of 1030 may be performed by a sidelink message transmitting manager as described with reference to FIGS. 5 through 8.

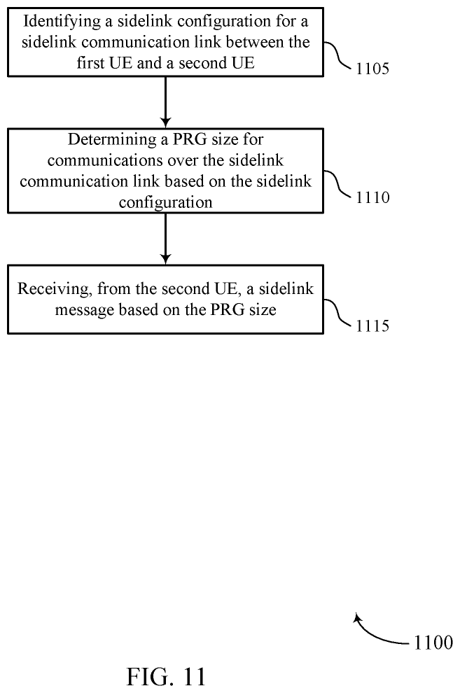

FIG. 11 shows a flowchart illustrating a method 1100 that supports techniques for sub-band precoding in sidelink communications in accordance with various aspects of the present disclosure. The operations of method 1100 may be implemented by a UE 115 or its components as described herein. For example, the operations of method 1100 may be performed by a communications manager as described with reference to FIGS. 5 through 8. In some examples, a UE may execute a set of instructions to control the functional elements of the UE to perform the functions described herein. Additionally or alternatively, a UE may perform aspects of the functions described herein using special-purpose hardware.

At 1105, the UE may identify a sidelink configuration for a sidelink communication link between the first UE and a second UE. The operations of 1105 may be performed according to the methods described herein. In some examples, aspects of the operations of 1105 may be performed by a sidelink configuration manager as described with reference to FIGS. 5 through 8.

At 1110, the UE may determine a PRG size for communications over the sidelink communication link based on the sidelink configuration. The operations of 1110 may be performed according to the methods described herein. In some examples, aspects of the operations of 1110 may be performed by a PRG size manager as described with reference to FIGS. 5 through 8.

At 1115, the UE may receive, from the second UE, a sidelink message based on the PRG size. The operations of 1115 may be performed according to the methods described herein. In some examples, aspects of the operations of 1115 may be performed by a sidelink message receiving manager as described with reference to FIGS. 5 through 8.

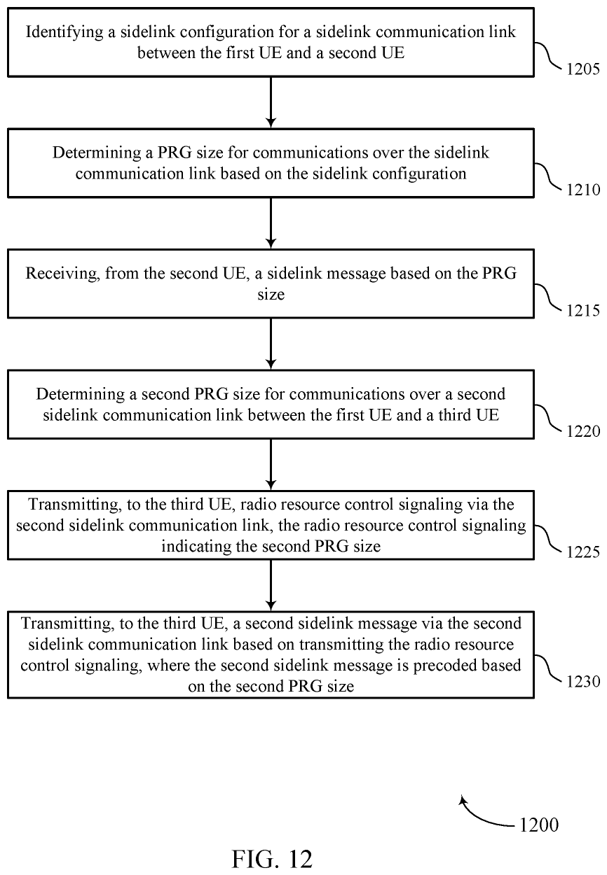

FIG. 12 shows a flowchart illustrating a method 1200 that supports techniques for sub-band precoding in sidelink communications in accordance with various aspects of the present disclosure. The operations of method 1200 may be implemented by a UE 115 or its components as described herein. For example, the operations of method 1200 may be performed by a communications manager as described with reference to FIGS. 5 through 8. In some examples, a UE may execute a set of instructions to control the functional elements of the UE to perform the functions described herein. Additionally or alternatively, a UE may perform aspects of the functions described herein using special-purpose hardware.

At 1205, the UE may identify a sidelink configuration for a sidelink communication link between the first UE and a second UE. The operations of 1205 may be performed according to the methods described herein. In some examples, aspects of the operations of 1205 may be performed by a sidelink configuration manager as described with reference to FIGS. 5 through 8.

At 1210, the UE may determine a PRG size for communications over the sidelink communication link based on the sidelink configuration. The operations of 1210 may be performed according to the methods described herein. In some examples, aspects of the operations of 1210 may be performed by a PRG size manager as described with reference to FIGS. 5 through 8.

At 1215, the UE may receive, from the second UE, a sidelink message based on the PRG size. The operations of 1215 may be performed according to the methods described herein. In some examples, aspects of the operations of 1215 may be performed by a sidelink message receiving manager as described with reference to FIGS. 5 through 8.

At 1220, the UE may determine a second PRG size for communications over a second sidelink communication link between the first UE and a third UE. The operations of 1220 may be performed according to the methods described herein. In some examples, aspects of the operations of 1220 may be performed by a PRG size manager as described with reference to FIGS. 5 through 8.

At 1225, the UE may transmit, to the third UE, radio resource control signaling via the second sidelink communication link, the radio resource control signaling indicating the second PRG size. The operations of 1225 may be performed according to the methods described herein. In some examples, aspects of the operations of 1225 may be performed by a RRC transmitting manager as described with reference to FIGS. 5 through 8.

At 1230, the UE may transmit, to the third UE, a second sidelink message via the second sidelink communication link based on transmitting the radio resource control signaling, where the second sidelink message is precoded based on the second PRG size. The operations of 1230 may be performed according to the methods described herein. In some examples, aspects of the operations of 1230 may be performed by a sidelink message transmitting manager as described with reference to FIGS. 5 through 8.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a first user equipment (UE), comprising:
receiving, from a second UE, sidelink control information over a sidelink communication link between the first UE and the second UE, the sidelink control information indicating a precoding resource block group (PRG) size;
determining the PRG size for communications over the sidelink communication link based at least in part on the sidelink control information; and
receiving, from the second UE, a sidelink message via the sidelink communication link based at least in part on the determined PRG size.

2. The method of claim 1, further comprising:
identifying, from the sidelink control information, a modulation and coding scheme index for the communications over the sidelink communication link, wherein determining the PRG size is based at least in part on the modulation and coding scheme index.

3. The method of claim 2, wherein determining the PRG size comprises:
determining the PRG size based at least in part on the modulation and coding scheme index satisfying one or more thresholds.

4. The method of claim 1, wherein the sidelink control information indicates the PRG size via a bit value, a sidelink control information format, a sidelink control information rate-matching offset, a target code rate, or any combination thereof, and wherein determining the PRG size is based at least in part on the bit value and a modulation and coding scheme index, the sidelink control information format, the sidelink control information rate-matching offset, the target code rate, or any combination thereof.

5. The method of claim 1, further comprising:
receiving a configuration message indicating one or more PRG sizes for communications over the sidelink communication link between the first UE and the second UE, wherein determining the PRG size is based at least in part on the one or more PRG sizes and the sidelink control information.

6. The method of claim 1, further comprising:
transmitting, to the second UE, a second sidelink message via the sidelink communication link based at least in part on determining the PRG size, wherein the second sidelink message is precoded based at least in part on the PRG size.

7. The method of claim 1, further comprising:
determining a second PRG size for communications over a second sidelink communication link between the first UE and a third UE;
transmitting, to the third UE, a second sidelink control information via the second sidelink communication link, the second sidelink control information indicating the second PRG size, the second sidelink control information comprising decoding information for decoding an additional sidelink control information different from the second sidelink control information; and
transmitting, to the third UE, a second sidelink message via the second sidelink communication link based at least in part on transmitting the second sidelink control information, wherein the second sidelink message is precoded based at least in part on the second PRG size.

8. The method of claim 7, further comprising:
determining one or more precoders for transmitting the second sidelink message based at least in part on the second PRG size, wherein transmitting the second sidelink message is based at least in part on determining the one or more precoders.

9. The method of claim 8, wherein determining the one or more precoders comprises:
determining an indication of a wideband precoding scheme or sub-band precoding scheme for transmitting the second sidelink message based at least in part on the second PRG size.

10. The method of claim 1, wherein a plurality of PRGs of the sidelink message are arranged based at least in part on a first resource block of a set of resources allocated for the sidelink message.

11. The method of claim 1, wherein a plurality of PRGs of the sidelink message are arranged based at least in part on a sidelink common resource block.

12. The method of claim 1, further comprising:
determining a bandwidth difference between a sub-channel bandwidth and a physical sidelink control channel bandwidth for communications over the sidelink communication link; and
determining one or more of the PRG size, the sub-channel bandwidth, or the physical sidelink control channel bandwidth based at least in part on the bandwidth difference being an integer multiple of the PRG size.

13. The method of claim 1, further comprising:
determining that the PRG size is equal to a sub-channel bandwidth of a set of resources allocated for the sidelink message.

14. The method of claim 1, further comprising:
determining that the PRG size is equal to a predefined value based at least in part on the PRG size being less than a bandwidth of a set of resources allocated for the sidelink message.

15. The method of claim 1, further comprising:
determining that the PRG size is equal to a bandwidth of a set of resources allocated for the sidelink message.

16. A method for wireless communication at a first user equipment (UE), comprising:
identifying a sidelink configuration for a sidelink communication link between the first UE and a second UE;
determining a PRG size for communications over the sidelink communication link based at least in part on the sidelink configuration; and
receiving, from the second UE, a sidelink message based at least in part on the PRG size.

17. The method of claim 16, wherein identifying the sidelink configuration comprises:
receiving, from the second UE, radio resource control signaling indicating the PRG size, wherein the PRG size is determined based at least in part on the radio resource control signaling.

18. The method of claim 16, wherein identifying the sidelink configuration comprises:
receiving an indication of one or more sets of resources allocated for communications over the sidelink communication link, wherein determining the PRG size is based at least in part on the indication of the one or more sets of resources allocated for communications over the sidelink communication link.

19. The method of claim 16, wherein identifying the sidelink configuration comprises:
receiving a control message comprising an indication of a sub-channel bandwidth associated with the sidelink communication link, wherein determining the PRG size is based at least in part on the indication of the sub-channel bandwidth.

20. The method of claim 19, wherein determining the PRG size comprises:
determining the PRG size based at least in part on the sub-channel bandwidth satisfying one or more thresholds.

21. The method of claim 16, further comprising:
receiving a control message comprising an indication of a quantity of sub-channels associated with the sidelink communication link, wherein determining the PRG size is based at least in part on the indication of the quantity of sub-channels associated with the sidelink communication link.

22. The method of claim 16, further comprising:
transmitting, to the second UE, a second sidelink message via the sidelink communication link based at least in part on the PRG size, wherein the second sidelink message is precoded based at least in part on the PRG size.

23. The method of claim 16, further comprising:
determining a second PRG size for communications over a second sidelink communication link between the first UE and a third UE;
transmitting, to the third UE, radio resource control signaling via the second sidelink communication link, the radio resource control signaling indicating the second PRG size; and
transmitting, to the third UE, a second sidelink message via the second sidelink communication link based at least in part on transmitting the radio resource control signaling, wherein the second sidelink message is precoded based at least in part on the second PRG size.

24. The method of claim 16, wherein a plurality of PRGs of the sidelink message are arranged based at least in part on a first resource block of a set of resources allocated for the sidelink message.

25. The method of claim 16, wherein a plurality of PRGs of the sidelink message are arranged based at least in part on a sidelink common resource block.

26. The method of claim 16, further comprising:
determining a bandwidth difference between a sub-channel bandwidth and a physical sidelink control channel bandwidth for communications over the sidelink communication link; and
determining one or more of the PRG size, the sub-channel bandwidth, or the physical sidelink control channel bandwidth based at least in part on the bandwidth difference being an integer multiple of the PRG size.

27. The method of claim 16, further comprising:
determining that the PRG size is equal to a sub-channel bandwidth of a set of resources allocated for the sidelink message.

28. The method of claim 16, further comprising:
determining that the PRG size is equal to a predefined value based at least in part on the PRG size being less than a bandwidth of a set of resources allocated for the sidelink message.

29. An apparatus for wireless communication at a first user equipment (UE), comprising:
a processor,
memory coupled with the processor; and
instructions stored in the memory and executable by the processor to cause the apparatus to:
receive, from a second UE, sidelink control information over a sidelink communication link between the first UE and the second UE, the sidelink control information indicating a precoding resource block group (PRG) size;
determine the PRG size for communications over the sidelink communication link based at least in part on the sidelink control information; and
receive, from the second UE, a sidelink message via the sidelink communication link based at least in part on the determined PRG size.

30. An apparatus for wireless communication at a first user equipment (UE), comprising:
a processor,
memory coupled with the processor; and
instructions stored in the memory and executable by the processor to cause the apparatus to:
identify a sidelink configuration for a sidelink communication link between the first UE and a second UE;
determine a PRG size for communications over the sidelink communication link based at least in part on the sidelink configuration; and
receive, from the second UE, a sidelink message based at least in part on the PRG size.
